(19) United States
(12) Patent Application Publication
(10) Pub. No.: US 2025/0350530 A1
(43) Pub. Date: Nov. 13, 2025

(54) METHOD AND APPARATUS FOR SUPPORTING NETWORK ENERGY SAVING

(71) Applicant: SAMSUNG ELECTRONICS CO., LTD., Suwon-si (KR)

(72) Inventors: Yanru WANG, Beijing (CN); Hong WANG, Beijing (CN); Lixiang XU, Beijing (CN)

(21) Appl. No.: 19/202,753

(22) Filed: May 8, 2025

(30) Foreign Application Priority Data
May 8, 2024 (CN) 202410565318.8
Aug. 7, 2024 (CN) 202411081209.5
Feb. 18, 2025 (CN) 202510174711.9

(51) Int. Cl. H04L 41/0806; H04W 52/02; H04W 74/0833

(52) U.S. Cl. CPC H04L 41/0806; H04W 52/0235; H04W 74/0833

(57) ABSTRACT

The disclosure relates to a 5G or 6G communication system for supporting higher data rates. The disclosure provides a method performed by a first base station. The method includes: transmitting, to a second base station, a first request message including first information on a request type for a provision of an UL WUS configuration associated with an NES cell of the first base station, wherein, in case that the request type is start, the first request message further includes information on the UL WUS configuration; receiving, from a terminal via the NES cell, request for an on-demand SIB 1, based on the UL WUS configuration; and transmitting, to the terminal via the NES cell, the on-demand SIB 1, based on the request for the on-demand SIB 1, wherein the UL WUS configuration is transmitted to the terminal via an SIB broadcasted by the second base station.

### CROSS-REFERENCE TO RELATED APPLICATIONS

This application is based on and claims priority under 35 U.S.C. § 119 to Chinese Patent Application No. 202410565318.8, 202411081209.5 and 202510174711.9 filed on May 8, 2024, Aug. 7, 2024, and Feb. 18, 2025, in the Chinese Intellectual Property Office, the disclosures of which are incorporated by reference herein in their entirety.

### BACKGROUND

### 1 Field

The disclosure relates to operations of a terminal, a base station, and a core network in a wireless communication. In particularly the disclosure relates a method and an apparatus to support network energy saving (NES).

### 2 Description of Related Art

In order to meet an increasing demand for wireless data communication services since a deployment of fourth generation (4G) communication system, efforts have been made to develop an improved fifth generation (5G) or pre-5G communication system. Therefore, the 5G or pre-5G communication system is also called “beyond 4G network” or “post LTE system.”

Fifth generation (5G) mobile communication technologies define broad frequency bands such that high transmission rates and new services are possible, and may be implemented not only in “Sub 6 GHz” bands such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

Initially, at the beginning of the development of 5G mobile communication technologies, in order to support services and to satisfy performance requirements in connection with an enhanced Mobile BroadBand (eMBB), an Ultra Reliable Low Latency Communications (URLLC), and a massive Machine-Type Communications (mMTC), there has been ongoing standardization regarding beamforming and a massive Multiple-Input Multiple-Output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of Bandwidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as a Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, a Non-Terrestrial Network (NTN) which is a UE-satellite direct communication system for providing coverage in an area in which communication with terrestrial networks is unavailable, and positioning.

Further, there has been ongoing standardization in air interface architecture/protocol regarding technologies such as Industrial Internet of Things (IIoT) for supporting new services through interworking and convergence with other industries, an Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on the UE positions.

As the 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research may be scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of the UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The existing on-demand system information block (SIB) 1 may be further improved, so a method for enhancing the on-demand system information block may achieve energy-saving effect.

### SUMMARY

The disclosure relates to operations of a terminal, a base station, and a core network in a wireless communication. In particularly, the disclosure relates a method and an apparatus to support network energy saving (NES).

Accordingly, an aspect of the disclosure is to provide a method and apparatus for managing an NES cell.

In addition, an aspect of the disclosure is related to a method and an apparatus for providing an on-demand system information block (SIB) 1 the idle/inactive terminal via the NES cell.

Furthermore, an aspect of the disclosure is related to a method and an apparatus for providing a configuration for an uplink wake-up signal to the idle/inactive-state terminal.

Additional aspects will be set forth in part in the description which follows and, in part, will be apparent from the description, or may be learned by practice of the presented embodiments. Aspects of the disclosure are to address at least the above-mentioned problems and/or disadvantages and to provide at least the advantages described below.

In accordance with an aspect of the disclosure, a method performed by a first base station in a wireless communication system is provided. The method includes transmitting, to a second base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration; receiving, from a terminal via the NES cell, request for an on-demand system information block (SIB) 1, based on the UL WUS configuration; and transmitting, to the terminal via the NES cell, the on-demand SIB 1, based on the request for the on-demand SIB 1, wherein the UL WUS configuration is transmitted to the terminal via an SIB broadcasted by the second base station.

In accordance with an aspect of the disclosure, a method performed by a second base station in a wireless communication system is provided. The method includes receiving, from a first base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration; storing the UL WUS configuration; and transmitting, to a terminal, a system information block (SIB) including the UL WUS configuration, wherein the UL WUS configuration is used for obtaining an on-demand SIB 1 from the NES cell of the first base station.

In accordance with an aspect of the disclosure, a method performed by a first base station in a wireless communication system is provided. The first base station includes a transceiver; and a processor coupled to the transceiver and configured to: transmit, to a second base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration, receive, from a terminal via the NES cell, request for an on-demand system information block (SIB) 1, based on the UL WUS configuration, and transmit, to the terminal via the NES cell, the on-demand SIB 1, based on the request for the on-demand SIB 1, wherein the UL WUS configuration is transmitted to the terminal via an SIB broadcasted by the second base station.

In accordance with an aspect of the disclosure, a second base station in a wireless communication system is provided. The second base station includes a transceiver; and a processor coupled to the transceiver and configured to: receive, from a first base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration, store the UL WUS configuration, and transmit, to a terminal, a system information block (SIB) including the UL WUS configuration, wherein the UL WUS configuration is used for obtaining an on-demand SIB 1 from the NES cell of the first base station.

An embodiment of the disclosure provides a method performed by a sixth node in a wireless communication system, which includes: receiving an eleventh message from a fifth node, wherein the eleventh message includes system information block 1 (SIB1) related energy-saving information related to an energy-saving cell, wherein the energy-saving cell is a cell in the fifth node; receiving a fourteenth message from the fifth node, wherein the fourteenth message includes a threshold value for triggering the reporting of reception of an uplink wake-up signal used for obtaining SIB1 information of the energy-saving cell; transmitting a second message to a user equipment (UE), wherein the second message includes a third uplink wake-up signal configuration which is used to configure the uplink wake-up signal used for obtaining the SIB1 information of the energy-saving cell; receiving an uplink wake-up signal from the UE, wherein the uplink wake-up signal is transmitted based on the third uplink wake-up signal configuration; transmitting a fifteenth message to the fifth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value; and transmitting a twentieth message to the UE, wherein the twentieth message includes the SIB1 information related to the energy-saving cell.

According to embodiments of the disclosure, the method further includes: transmitting a tenth message to the fifth node, wherein the tenth message includes information related to whether the sixth node supports on-demand SIB1 of a neighboring cell.

According to embodiments of the disclosure, the method further includes: receiving a ninth message from the fifth node, wherein the ninth message includes information related to a request for supporting on-demand SIB1 of the energy-saving cell, wherein the tenth message is in response to the ninth message.

According to embodiments of the disclosure, the method further includes: receiving a twenty-fourth message from the fifth node, wherein the twenty-fourth message includes a first uplink wake-up signal configuration related to the fifth node; and in case that a second uplink wake-up signal configuration related to the sixth node conflicts with the first uplink wake-up signal configuration, transmitting an updated second uplink wake-up signal configuration related to the sixth node to the fifth node, wherein the second uplink wake-up signal configuration includes the third uplink wake-up signal configuration.

An embodiment of the disclosure provides a method performed by a fifth node in a wireless communication system, which includes: transmitting an eleventh message to a sixth node, wherein the eleventh message includes system information block 1 (SIB1) related energy-saving information related to an energy-saving cell, wherein the energy-saving cell is a cell in the fifth node; transmitting a fourteenth message to the sixth node, wherein the fourteenth message includes a threshold value for triggering the reporting of reception of an uplink wake-up signal used for obtaining SIB1 information of the energy-saving cell; and receiving a fifteenth message from the sixth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value.

According to embodiments of the disclosure, the method further includes: transmitting a first message to a user equipment (UE), wherein the first message includes information related to on-demand SIB1 transmission of the energy-saving cell.

According to embodiments of the disclosure, the method further includes: receiving a tenth message from the sixth node, wherein the tenth message includes information related to whether the sixth node supports on-demand SIB1 of a neighboring cell.

According to embodiments of the disclosure, the method further includes: transmitting a ninth message to the sixth node, wherein the ninth message includes information related to a request for supporting on-demand SIB1 of the energy-saving cell, wherein the tenth message is in response to the ninth message.

According to embodiments of the disclosure, the method further includes: determining whether to enter an SIB1 normal transmission state and/or making a network energy-saving decision based on the fifteenth message.

An embodiment of the disclosure provides a method performed by user equipment (UE) in a wireless communication system, which includes: receiving a second message from a sixth node, wherein the second message includes a third uplink wake-up signal configuration which is used to configure an uplink wake-up signal used for obtaining SIB1 information of an energy-saving cell in a fifth node; transmitting an uplink wake-up signal to the sixth node, wherein the uplink wake-up signal is transmitted based on the third uplink wake-up signal configuration; and receiving a twentieth message from the sixth node, wherein the twentieth message includes system information block 1 (SIB1) information related to the energy-saving cell, wherein the SIB1 information related to the energy-saving cell is determined based on an eleventh message received by the sixth node from the fifth node, wherein the eleventh message includes SIB1 related energy-saving information related to the energy-saving cell in the fifth node and a threshold value for triggering the reporting of reception of an uplink wake-up signal used for obtaining SIB1 information of the energy-saving cell, wherein the threshold value is used for the sixth node to transmit a fifteenth message to the fifth node, wherein the fifteenth message includes the reception of the uplink wake-up signal used for obtaining the SIB1 information of the energy-saving cell.

According to embodiments of the disclosure, the method further includes: receiving a first message from the fifth node, wherein the first message includes information related to on-demand SIB1 transmission of the energy-saving cell.

An embodiment of the disclosure provides a method performed by a sixth node in a wireless communication system, including: receiving a twenty-fourth message from a fifth node, wherein the twenty-fourth message includes a first uplink wake-up signal configuration related to the fifth node; and in case that a second uplink wake-up signal configuration related to the sixth node conflicts with the first uplink wake-up signal configuration, transmitting an updated second uplink wake-up signal configuration related to the sixth node to the fifth node, wherein the second uplink wake-up signal configuration includes a third uplink wake-up signal configuration.

According to embodiments of the disclosure, the method further includes: receiving an eleventh message from a fifth node, wherein the eleventh message includes system information block 1 (SIB1) related energy-saving information related to an energy-saving cell, wherein the energy-saving cell is a cell in the fifth node; receiving a fourteenth message from the fifth node, wherein the fourteenth message includes a threshold value for triggering the reporting of reception of an uplink wake-up signal used for obtaining SIB1 information of the energy-saving cell; transmitting a second message to a user equipment (UE), wherein the second message includes a third uplink wake-up signal configuration which is used to configure the uplink wake-up signal used for obtaining the SIB1 information of the energy-saving cell; receiving an uplink wake-up signal from the UE, wherein the uplink wake-up signal is transmitted based on the third uplink wake-up signal configuration; transmitting a fifteenth message to the fifth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value; and transmitting a twentieth message to the UE, wherein the twentieth message includes the SIB1 information related to the energy-saving cell.

Embodiments of the disclosure provide a node device in a wireless communication system, including: a transceiver configured to transmit and receive signals; and a processor coupled to the transceiver and configured to perform methods performed by any node in a wireless communication system according to embodiments of the disclosure.

Embodiments of the disclosure provide a user equipment (UE) in a wireless communication system, including: a transceiver configured to transmit and receive signals; and a processor coupled to the transceiver and configured to perform methods performed by a user equipment (UE) in a wireless communication system according to embodiments of the disclosure.

Embodiments of the disclosure provide a computer-readable medium having stored thereon computer-readable instructions which, when executed by a processor, perform methods performed by any node and/or a user equipment in a wireless communication system according to embodiments of the disclosure.

According to an embodiment of the disclosure, the on-demand SIB1 transmission is performed effectively by exchanging information including an uplink wake-up signal configuration between the network nodes and/or terminal.

The effects obtainable in the disclosure are not limited to the above-mentioned effects, and other effects not mentioned herein will be clearly understood from the following description by those skilled in the art to which the disclosure belongs.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain embodiments of the disclosure may be more apparent from the following description taken in conjunction with the accompanying drawings, in which:

FIG. 1 illustrates a system architecture of SAE according to various embodiments of the disclosure;

FIG. 2 illustrates a system architecture according to various embodiments of the disclosure;

FIG. 3A illustrates a flowchart of a method performed by a sixth node in a wireless communication system according to embodiments of the disclosure;

FIG. 3B illustrates a flowchart of a method performed by a fifth node in a wireless communication system according to embodiments of the disclosure;

FIG. 3C illustrates a flowchart of a method performed by a user equipment (UE) in a wireless communication system according to embodiments of the disclosure;

FIG. 3D illustrates a flowchart of a method performed by a sixth node in a wireless communication system according to embodiments of the disclosure;

FIG. 4A illustrates a method for supporting network energy-saving according to embodiments of the disclosure;

FIG. 4B illustrates a method for supporting network energy-saving according to embodiments of the disclosure;

FIG. 4C illustrates a method for supporting network energy-saving according to embodiments of the disclosure;

FIG. 4D illustrates a method for supporting network energy-saving according to embodiments of the disclosure;

FIG. 4E illustrates a method for supporting network energy-saving according to embodiments of the disclosure;

FIG. 4F illustrates a method for supporting network energy-saving according to embodiments of the disclosure;

FIG. 5A illustrates a method for supporting network energy-saving according to embodiments of the disclosure;

FIG. 5B illustrates a method for supporting network energy-saving according to embodiments of the disclosure;

FIG. 6A illustrates a method for supporting network energy-saving according to embodiments of the disclosure;

FIG. 6B illustrates a method for supporting network energy-saving according to embodiments of the disclosure;

FIG. 6C illustrates a method for supporting network energy-saving according to embodiments of the disclosure;

FIG. 6D illustrates a method for supporting network energy-saving according to embodiments of the disclosure;

FIG. 6E illustrates a method for supporting network energy-saving according to embodiments of the disclosure;

FIG. 6F illustrates a method for supporting network energy-saving according to embodiments of the disclosure;

FIG. 6G illustrates a method for supporting network energy-saving according to embodiments of the disclosure;

FIG. 6H illustrates a method for supporting network energy-saving according to embodiments of the disclosure;

FIG. 6I illustrates a method for supporting network energy-saving according to embodiments of the disclosure;

FIG. 6J illustrates a method for supporting network energy-saving according to embodiments of the disclosure;

FIG. 6K illustrates a method for supporting network energy-saving according to embodiments of the disclosure;

FIG. 7 illustrates a method for supporting network energy-saving according to embodiments of the disclosure;

FIG. 8 illustrates a network node according to embodiments of the disclosure; and

FIG. 9 illustrates a terminal according to embodiments of the disclosure.

### DETAILED DESCRIPTION

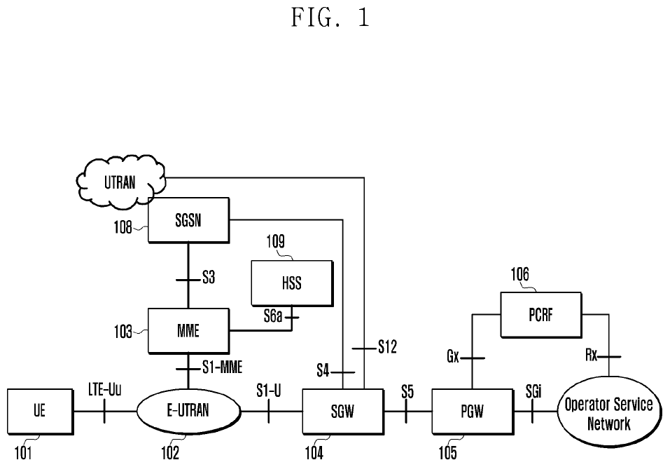

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art may recognize that various changes and modifications of the various embodiments described herein can be made without departing from the scope and spirit of the disclosure. In addition, descriptions of well-known functions and constructions may be omitted for clarity and conciseness.

In order to make the objectives, technical schemes and advantages of the embodiments of the disclosure, a clear and complete description will be made with respect to the technical schemes of the embodiments of the disclosure, in conjunction with the accompanying drawings of the embodiments of the disclosure. Apparently, the described embodiments are a part of the embodiments of the disclosure, not all of the embodiments. Based on the described embodiments of the disclosure, all other embodiments obtained by common skilled in the art without creative labor belong to the protection scope of the disclosure.

Before undertaking the detailed descriptions below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect to or with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The function associated with any particular controller may be centralized or distributed, whether locally or remotely. The phrase “at least one of,” when used with a list of items, means that different combinations of one or more of the listed items may be used, and only one item in the list may be needed. For example, “at least one of the following: A, B, and C” includes any of the following combinations: A, B, C, A and B, A and C, B and C, and A and B and C. For example, “at least one of A, B, or C “includes any of the following combinations: A, B, C, A and B, A and C, B and C, and A and B and C.

Furthermore, the expressions “if” and “in case that” as used in the present specification or claims may, depending on the context, be interpreted to mean “when,” “in response to,” “based on,” or “according to,” and such expressions may be used interchangeably. In addition, other expressions having substantially the same meaning may also be used in place of these expressions, as long as the technical features of the present disclosure are not impaired. Furthermore, the term “configured” to indicate that predetermined information is set by a base station or a network may imply that the predetermined information is received via a predetermined message (for example, an RRC message).

In addition, various functions described below can be implemented or supported by one or more computer programs, each of which is formed by computer-readable program code and embodied in a computer-readable medium. The terms “application” and “program” refer to one or more computer programs, software components, instruction sets, procedures, functions, objects, classes, instances, related data or parts thereof appropriate for implementation in suitable computer-readable program code. The phrase “computer readable program code” includes any type of computer code, including source code, objective code and executable code. The phrase “computer readable medium” includes any type of medium that can be accessed by a computer, such as Read-Only Memory (ROM), Random Access Memory (RAM), hard disk drive, compact disk (CD), digital video disk (DVD) or any other type of memory. A “non-transitory” computer-readable medium excludes wired, wireless, optical or other communication links that transfer transitory electrical or other signals. A non-transitory computer-readable medium includes a medium in which data can be stored permanently and a medium in which data can be stored and rewritten later, such as rewritable optical disks or erasable memory devices.

As described above, it should be noted that each block of the flowcharts and combinations of the flowcharts described in the disclosure may be performed by one or more computer programs including instructions. The entirety of the one or more computer programs may be stored in a single memory device, or the one or more computer programs may be stored in a plurality of memory devices in a distributed manner.

In addition, the functions or operations described in the disclosure may be processed by a single processor or a combination of processors. The single processor or the combination of processors may be a circuit that performs processing and may include an application processor (AP, e.g., a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near-field communication (NFC) chip, a connectivity chip, a sensor controller, a touch controller, a fingerprint sensor controller, a display driver integrated circuit (IC), an audio codec (CODEC) chip, a universal serial bus (USB) controller, a camera controller, an image processing IC, a microprocessor unit (MPU), a system on chip (SoC), an IC, or a similar circuit.

Furthermore, it should be noted that various embodiments in the claims and descriptions of the disclosure may be implemented in the form of hardware, software, or a combination of hardware and software. Such software may be stored in a non-transitory computer-readable storage medium. The non-transitory computer-readable storage medium stores one or more computer programs (software modules), and the one or more computer programs include computer-executable instructions which, when executed individually or collectively by one or more processors of an electronic device, operate the electronic device to perform the method according to the disclosure.

The software may be stored in a transient or non-transitory storage device, for example, in the form of read-only memory (ROM) (regardless of whether it is erasable or rewritable), or random access memory (RAM), memory chips, devices, or integrated circuits (ICs). Also, the software may be stored in optically or magnetically readable media such as compact discs (CDs), digital versatile discs (DVDs), magnetic disks, or magnetic tapes. It should be understood that the storage devices and storage media are examples of non-transitory machine-readable storage media suitable for storing a program for implementing various embodiments of the disclosure.

Accordingly, various embodiments provide a program including code for implementing a device or method according to any one of the claims of the disclosure, and a non-transitory machine-readable storage medium storing such a program.

The terms used herein to describe the embodiments of the present application is not intended to limit and/or define the scope of the present application. For example, unless otherwise defined, the technical or scientific terms used in the disclosure should have common meanings as understood by common skilled in the art to which the present application belongs.

It should be understood that “first,” “second” and similar words used in the disclosure do not indicate any order, quantity or importance, but are only used to distinguish different components. Unless clearly indicated otherwise in the context, similar words such as “a,” “an,” “the” and the like in the singular form do not indicate a quantitative limitation, but indicate the existence of at least one.

As used herein, any reference to “one example” or “an example,” “one embodiment” or “an embodiment” means that a particular element, feature, structure or characteristic described in conjunction with the embodiment is included in at least one embodiment. The appearances of the phrases “in one embodiment” or “in one example” in different places in the specification are not necessarily all referring to the same embodiment.

As used herein, “a part of” a certain thing means “at least some of” this thing, so it may mean being less than the entirety thereof or being the entirety thereof. Therefore, “a part of” the thing includes the whole thing as a special case, that is, an example in which the whole thing is a part of the thing.

It will be further understood that words such as “include,” “contain” or the like means that the elements or objects appearing preceding the word encompass the elements or objects listed behind the word as well as their equivalents, without excluding other elements or objects. Words such as “connect,” “interconnect” or the like are not limited to physical or mechanical connections, but may include electrical connection, whether direct or indirect. “up,” “down,” “left” and “right” are only used to indicate relative positional relationships. When the absolute position of the described object changes, accordingly, the relative positional relationship may change as well.

The various embodiments discussed below for describing the principle of the disclosure in this patent document are for illustration only, and should not be construed as limiting the scope of the disclosure in any way. Those skilled in the art will understand that the principle of the disclosure may be implemented in any suitably arranged wireless communication system. For example, although the following detailed description of the embodiments of the disclosure will focus on LTE and 5G communication systems, those skilled in the art can understand that the main points of the disclosure can also be applied to other communication systems with similar technical backgrounds and channel formats, with slight modifications and basically without departing from the scope of the disclosure. The schemes of the embodiments of the present application may be applied to various communication systems.

For example, the communication systems may include a Global System for Mobile communications (GSM) system, a Code Division Multiple Access (CDMA) system, a Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunication System (UMTS), worldwide interoperability for microwave access (WiMAX) communication system, fifth generation (5th generation, 5G) system or New Radio (NR), etc. In addition, the schemes of the embodiments of the present application may be applied to future-oriented communication technologies. In addition, the schemes of the embodiments of the present application may be applied to future-oriented communication technologies.

For example, the base station may be at least one of a gNode B, an eNode B (eNB), a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) is a wireless transmission path through which signals are transmitted from a base station to a terminal, and the uplink (UL) is a wireless transmission path through which signals are transmitted from a terminal to a base station.

Accordingly, the various embodiments discussed below for describing the principles of the disclosure herein are for illustration purposes only and should not be interpreted as limiting the scope of the disclosure in any way. Those skilled in the art will understand that the principles of the disclosure may be implemented in any suitably arranged wireless communication system. Although the following detailed description of the embodiments of the disclosure will be directed to 5G, those skilled in the art can understand that the main points of the disclosure may also be applied to other communication systems (for example, beyond 5G (B5G) or 6G) with similar technical backgrounds and channel formats with slight modifications without departing from the scope of the disclosure.

Hereinafter, the embodiments of the disclosure will be described in detail with reference to the accompanying drawings. It should be noted that the same reference numerals in different drawings will be used to refer to the same elements already described.

The following description with reference to the accompanying drawings is provided to assist in a comprehensive understanding of various embodiments of the disclosure as defined by the claims and their equivalents. The description includes various specific details to assist in that understanding but should be regarded as exemplary only. Accordingly, the common skilled in the art will recognize that various changes and modifications to the various embodiments described herein can be made without departing from the scope and spirit of the disclosure. In addition, descriptions of well-known functions and structures may be omitted for clarity and conciseness.

The terms and wordings used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purpose only, but not for the purpose of limiting the disclosure as defined by the appended claims and their equivalents.

It should be understood that the singular forms “a,” “an,” and “the” include plural referents, unless clearly indicated otherwise in the context. Thus, for example, reference to “a component surface” includes reference to one or more of such surfaces.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

Figures discussed below and various embodiments for describing the principles of the disclosure in this patent document are only for illustration and should not be interpreted as limiting the scope of the disclosure in any way. Those skilled in the art may understand that the principles of the disclosure can be implemented in any suitably arranged system or device.

FIG. 1 illustrates a system architecture 100 of system architecture evolution (SAE). A user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

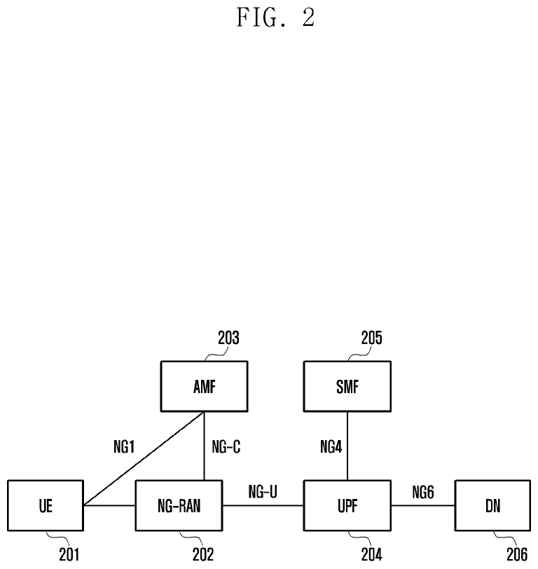

FIG. 2 illustrates a system architecture 200 according to various embodiments of the disclosure. Other embodiments of the system architecture 200 can be used without departing from the scope of the disclosure.

A user equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Nodes and/or entities mentioned in the disclosure may include: gNB, gNB central unit (gNB-CU), gNB distributed unit (gNB-DU), gNB central unit control plane (gNB-CU-CP), gNB central unit user plane (gNB CU-UP), en-gNB, eNB, ng-eNB, UE, access and mobility management function (AMF), session management function (SMF), mobility management entity (MME) and other network entities or network logic units, and cells and/or beams managed by them, etc.

The signal strength and/or signal quality mentioned in the disclosure may be a received signal strength indicator (RSSI), a reference signal receiving power, RSRP), a reference signal receiving quality (RSRQ), and a signal to interference plus noise ratio (SINR), etc.

The network self-optimization decision mentioned in the disclosure may include network energy-saving, load balancing, coverage optimization, mobility optimization and/or management, network configuration update, etc.

In the disclosure, time can be represented by one or more of the following: timestamp, time point, time interval, timer, period of time, time length, time period, time spacing, etc. The time length may be the length of time from a certain time point, which may be the current time. The time may be a relative time or an absolute time. In some embodiments, the period of time may be represented by separate fields, for example, by a combination of a start time and an end time, or by a combination of a start time and a time period.

Furthermore, in the disclosure, state and mode can refer to each other.

The information and/or fields described in the disclosure may be an average value, an instantaneous value, a maximum value, a minimum value, etc., which is not limited herein.

The information and/or fields described in the disclosure may be used to represent one or more of those following situations: uplink, downlink, uplink and downlink, uplink or downlink.

In the disclosure, a beam may refer to a synchronization signal and physical broadcast channel (PBCH) block (SSB) beam, or any other beam.

In the disclosure, a user equipment (UE), a user, a terminal and the like can refer to each other.

In the disclosure, reception of the uplink wake-up signal and reception condition of the uplink wake-up signal can refer to each other.

In the disclosure, a cell may also be extended to refer to one or more beams corresponding to the cell. If a cell refers to one or more beams corresponding to the cell, a cell identification and/or identification list may be extended to refer to one or more of the following: a cell identification and/or identification list, a beam identification and/or identification list.

In the disclosure, a normal cell is any cell that transmits an uplink wake-up signal configuration of an energy-saving cell, and/or any cell that receives an uplink wake-up signal for requesting and/or waking up an energy-saving cell. A normal cell may be a cell in a non-energy-saving state or another energy-saving cell other than an energy-saving cell.

In the disclosure, an uplink wake-up signal may be used to wake up an energy-saving cell by means of an uplink signal. For example, it may be used for the UE to request and/or wake up an energy-saving cell to transmit (on-demand) SIB1 information. The uplink wake-up signal may be an uplink wake-up signal of an energy-saving cell.

In the disclosure, a broadcast message may be any broadcast message. In an embodiment, a broadcast message may be any System Information Block and/or Master Information Block.

In the disclosure, SIB1 may be extended to any broadcast message.

In the disclosure, the case where a message is transmitted in a broadcast message may be exemplified by taking a transmission of a node DU to a UE as an example. This case may also be extended to a transmission of a node DU to a UE through a corresponding node CU, or a transmission of a node CU to a UE.

Exemplary embodiments of the disclosure are further described below with reference to the accompanying drawings.

The text and drawings are provided as examples only to help understand the disclosure. They should not be construed as limiting the scope of the disclosure in any way. Although certain embodiments and examples have been provided, based on the disclosure herein, it is obvious to those skilled in the art that changes can be made to the illustrated embodiments and examples without departing from the scope of the disclosure.

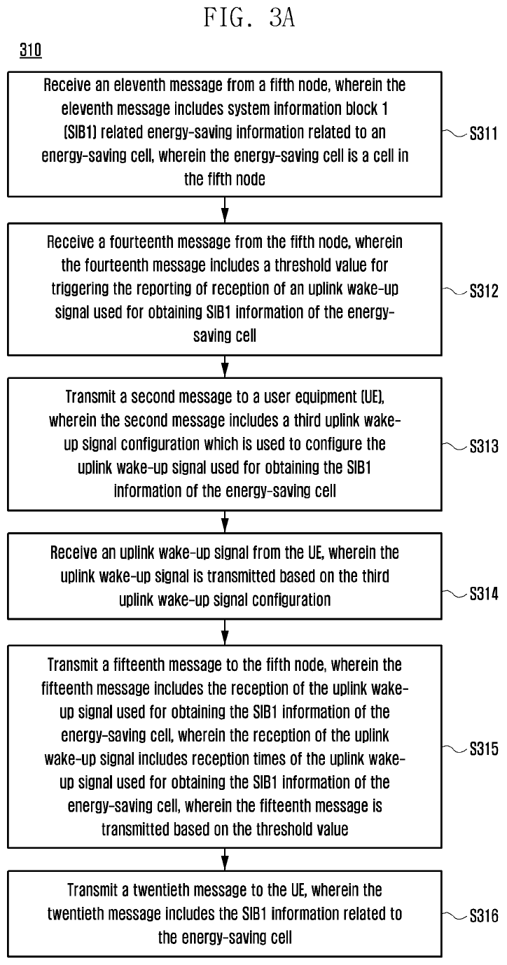

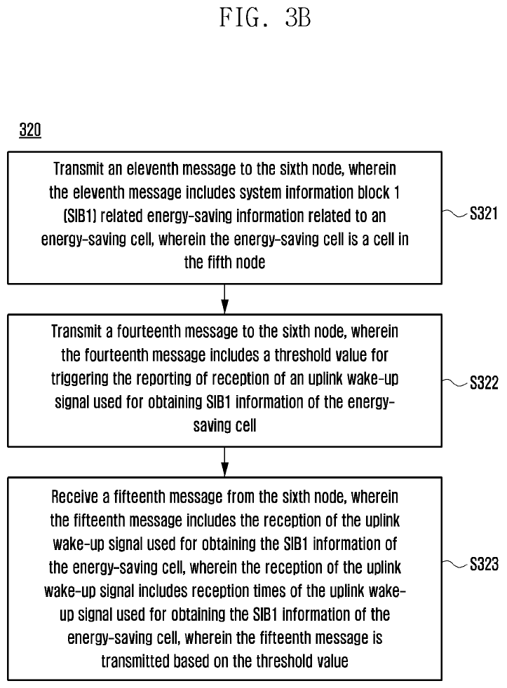

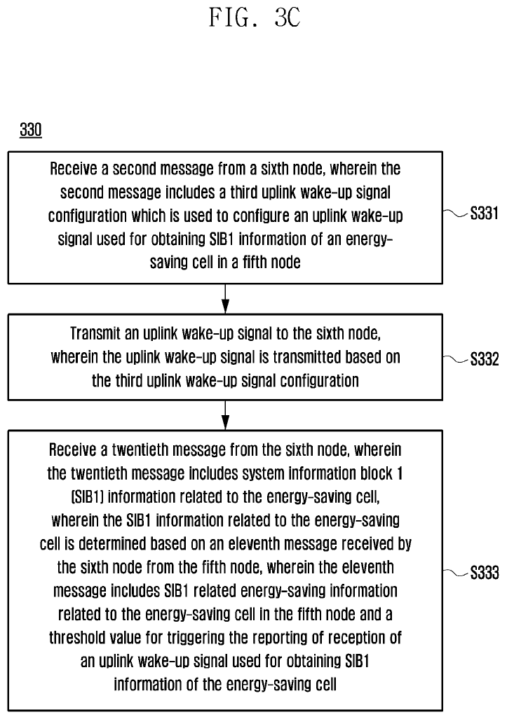

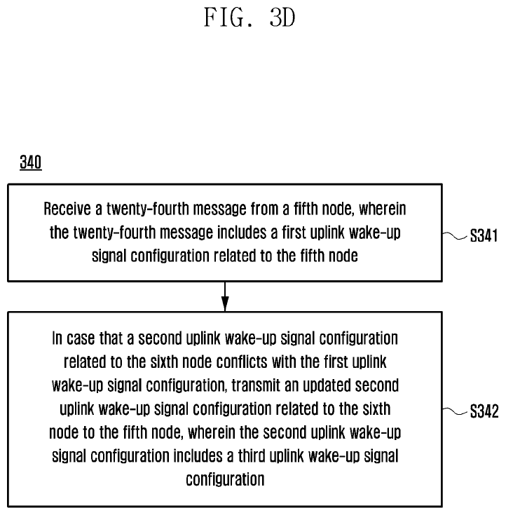

Next, FIG. 3A illustrates a flowchart of a method 310 performed by a sixth node in a wireless communication system according to embodiments of the disclosure.

As shown in FIG. 3A, a method 310 performed by a sixth node in a wireless communication system according to embodiments of the disclosure may include: in step S311, receiving an eleventh message from a fifth node, wherein the eleventh message includes system information block 1 (SIB1) related energy-saving information related to an energy-saving cell, wherein the energy-saving cell is a cell in the fifth node; in step S312, receiving a fourteenth message from the fifth node, wherein the fourteenth message includes a threshold value for triggering the reporting of reception of an uplink wake-up signal used for obtaining SIB1 information of the energy-saving cell; in step S313, transmitting a second message to a user equipment (UE), wherein the second message includes a third uplink wake-up signal configuration which is used to configure the uplink wake-up signal used for obtaining the SIB1 information of the energy-saving cell; in step S314, receiving an uplink wake-up signal from the UE, wherein the uplink wake-up signal is transmitted based on the third uplink wake-up signal configuration; in step S315, transmitting a fifteenth message to the fifth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value; and in step S316, transmitting a twentieth message to the UE, wherein the twentieth message includes the SIB1 information related to the energy-saving cell.

According to embodiments of the disclosure, the method further includes: transmitting a tenth message to the fifth node, wherein the tenth message includes information related to whether the sixth node supports on-demand SIB1 of a neighboring cell.

According to embodiments of the disclosure, the method further includes: receiving a ninth message from the fifth node, wherein the ninth message includes information related to a request for supporting on-demand SIB1 of the energy-saving cell, wherein the tenth message is in response to the ninth message.

According to embodiments of the disclosure, the method further includes: receiving a twenty-fourth message from the fifth node, wherein the twenty-fourth message includes a first uplink wake-up signal configuration related to the fifth node; and in case that a second uplink wake-up signal configuration related to the sixth node conflicts with the first uplink wake-up signal configuration, transmitting an updated second uplink wake-up signal configuration related to the sixth node to the fifth node, wherein the second uplink wake-up signal configuration includes the third uplink wake-up signal configuration.

FIG. 3B illustrates a flowchart of a method 320 performed by a fifth node in a wireless communication system according to embodiments of the disclosure.

As shown in FIG. 3B, a method 320 performed by a fifth node in a wireless communication system according to embodiments of the disclosure may include: in step S321, transmitting an eleventh message to the sixth node, wherein the eleventh message includes system information block 1 (SIB1) related energy-saving information related to an energy-saving cell, wherein the energy-saving cell is a cell in the fifth node; in step S322, transmitting a fourteenth message to the sixth node, wherein the fourteenth message includes a threshold value for triggering the reporting of reception of an uplink wake-up signal used for obtaining SIB1 information of the energy-saving cell; and in step S323, receiving a fifteenth message from the sixth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value.

According to embodiments of the disclosure, the method further includes: transmitting a first message to a user equipment (UE), wherein the first message includes information related to on-demand SIB1 transmission of the energy-saving cell.

According to embodiments of the disclosure, the method further includes: receiving a tenth message from the sixth node, wherein the tenth message includes information related to whether the sixth node supports on-demand SIB1 of a neighboring cell.

According to embodiments of the disclosure, the method further includes: transmitting a ninth message to the sixth node, wherein the ninth message includes information related to a request for supporting on-demand SIB1 of the energy-saving cell, wherein the tenth message is in response to the ninth message.

According to embodiments of the disclosure, the method further includes: determining whether to enter an SIB1 normal transmission state and/or making a network energy-saving decision based on the fifteenth message.

FIG. 3C illustrates a flowchart of a method 330 performed by a user equipment (UE) in a wireless communication system according to embodiments of the disclosure.

As shown in FIG. 3C, a method 330 performed by a user equipment (UE) in a wireless communication system according to embodiments of the disclosure may include: in step S331, receiving a second message from a sixth node, wherein the second message includes a third uplink wake-up signal configuration which is used to configure an uplink wake-up signal used for obtaining SIB1 information of an energy-saving cell in a fifth node; in step S332, transmitting an uplink wake-up signal to the sixth node, wherein the uplink wake-up signal is transmitted based on the third uplink wake-up signal configuration; and in step S333, receiving a twentieth message from the sixth node, wherein the twentieth message includes system information block 1 (SIB1) information related to the energy-saving cell, wherein the SIB1 information related to the energy-saving cell is determined based on an eleventh message received by the sixth node from the fifth node, wherein the eleventh message includes SIB1 related energy-saving information related to the energy-saving cell in the fifth node and a threshold value for triggering the reporting of reception of an uplink wake-up signal used for obtaining SIB1 information of the energy-saving cell, wherein the threshold value is used for the sixth node to transmit a fifteenth message to the fifth node, wherein the fifteenth message includes the reception of the uplink wake-up signal used for obtaining the SIB1 information of the energy-saving cell.

According to embodiments of the disclosure, the method further includes: receiving a first message from the fifth node, wherein the first message includes information related to on-demand SIB1 transmission of the energy-saving cell.

FIG. 3D illustrates a flowchart of a method 340 performed by a sixth node in a wireless communication system according to embodiments of the disclosure.

As shown in FIG. 3D, a method 340 performed by a sixth node in a wireless communication system according to embodiments of the disclosure may include: in step S341, receiving a twenty-fourth message from a fifth node, wherein the twenty-fourth message includes a first uplink wake-up signal configuration related to the fifth node; and in step S342, in case that a second uplink wake-up signal configuration related to the sixth node conflicts with the first uplink wake-up signal configuration, transmitting an updated second uplink wake-up signal configuration related to the sixth node to the fifth node, wherein the second uplink wake-up signal configuration includes a third uplink wake-up signal configuration.

According to embodiments of the disclosure, the method further includes: receiving an eleventh message from a fifth node, wherein the eleventh message includes system information block 1 (SIB1) related energy-saving information related to an energy-saving cell, wherein the energy-saving cell is a cell in the fifth node; receiving a fourteenth message from the fifth node, wherein the fourteenth message includes a threshold value for triggering the reporting of reception of an uplink wake-up signal used for obtaining SIB1 information of the energy-saving cell; transmitting a second message to a user equipment (UE), wherein the second message includes a third uplink wake-up signal configuration which is used to configure the uplink wake-up signal used for obtaining the SIB1 information of the energy-saving cell; receiving an uplink wake-up signal from the UE, wherein the uplink wake-up signal is transmitted based on the third uplink wake-up signal configuration; transmitting a fifteenth message to the fifth node, wherein the fifteenth message includes the reception of the uplink wake-up signal used for obtaining the SIB1 information of the energy-saving cell, wherein the reception of the uplink wake-up signal includes reception times of the uplink wake-up signal used for obtaining the SIB1 information of the energy-saving cell, wherein the fifteenth message is transmitted based on the threshold value; and transmitting a twentieth message to the UE, wherein the twentieth message includes the SIB1 information related to the energy-saving cell.

It should be understood that methods 310, 320, 330, 340, etc. according to embodiments of the disclosure may further include any method or step described in connection with various examples, aspects, drawings, etc. of the disclosure.

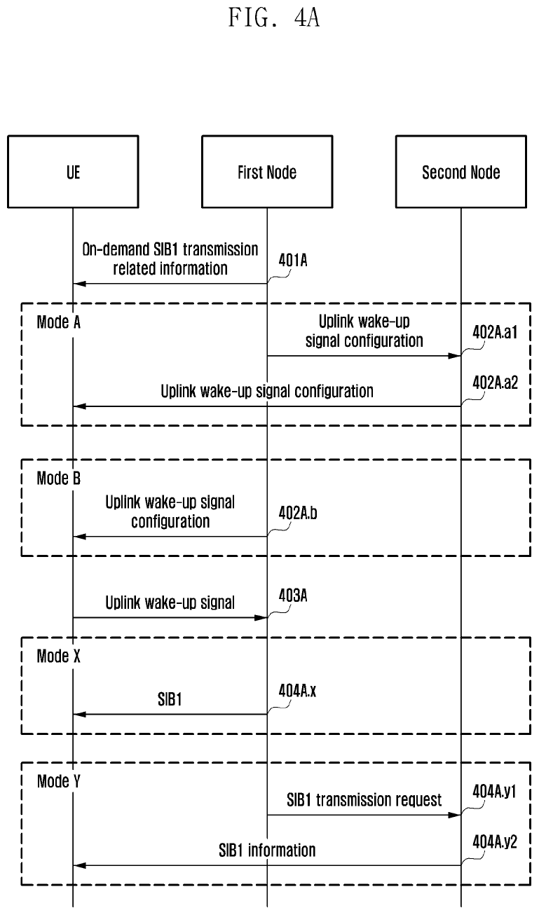

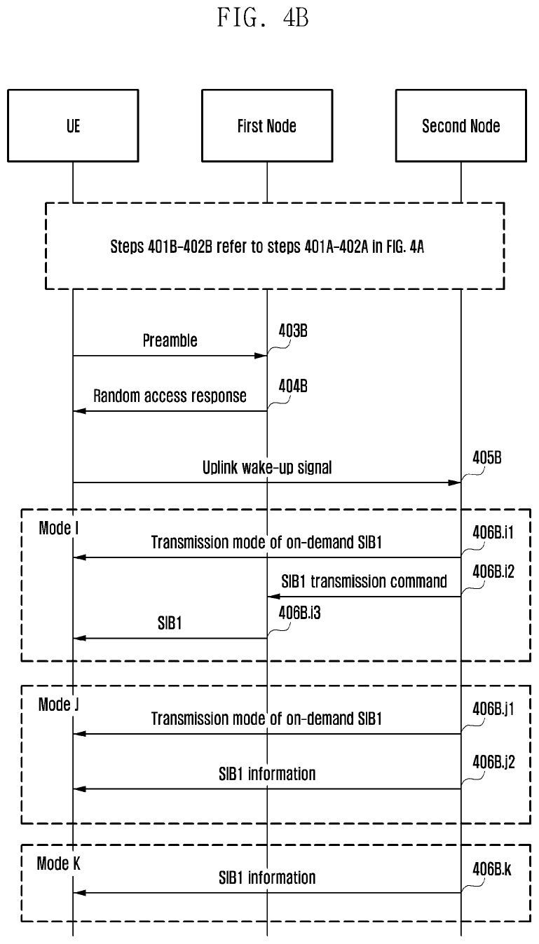

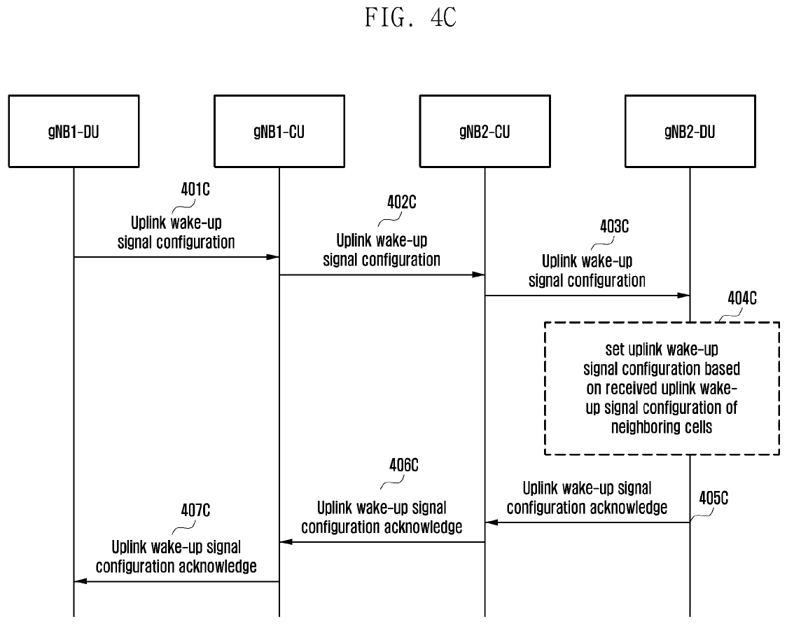

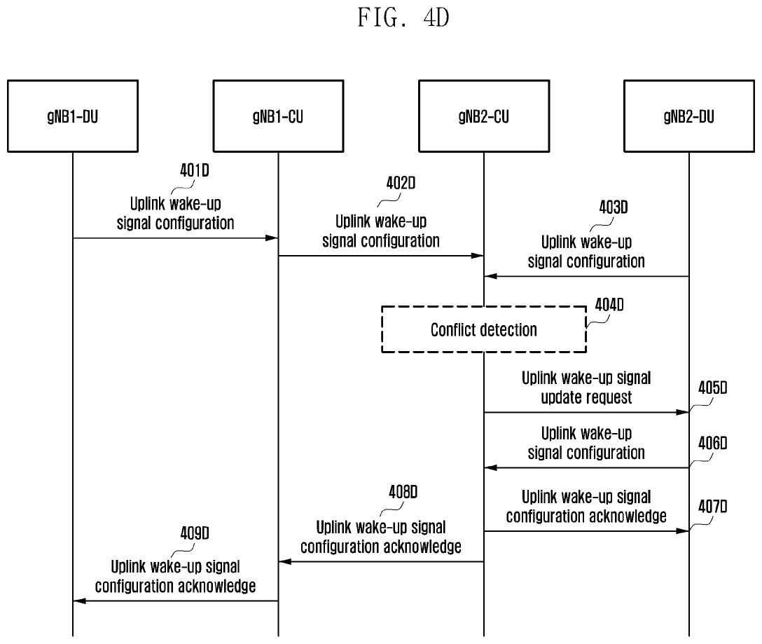

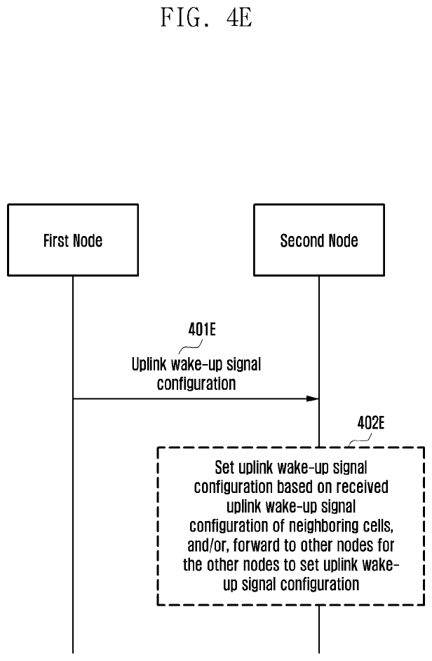

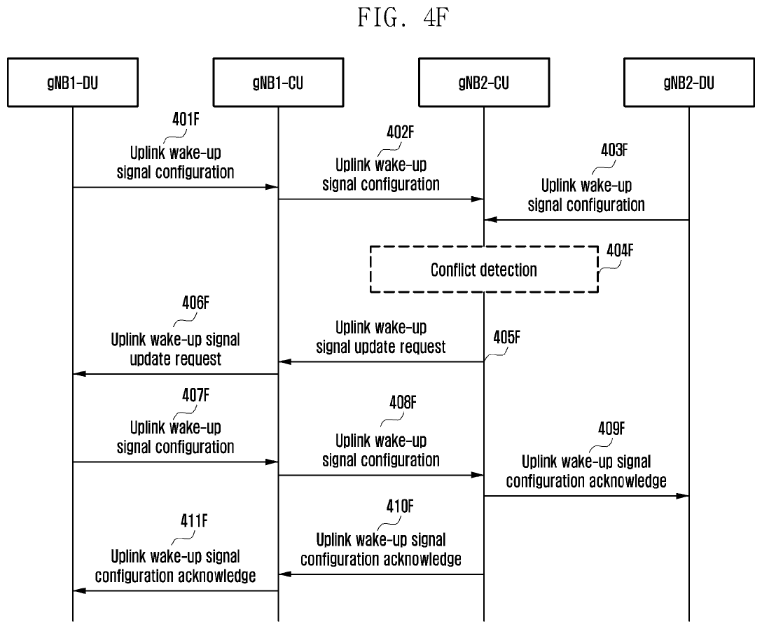

FIG. 4A illustrates a method for supporting network energy-saving according to embodiments of the disclosure. Specifically, FIG. 4A shows a process of exchanging on-demand SIB1 related information between nodes, so that the UE can request a node to transmit SIB1 information. For example, in an embodiment, the first node may be a gNB DU where an energy-saving cell is located, and the second node may be a gNB CU where an energy-saving cell is located. In another embodiment, for example, the first node may be a gNB where an energy-saving cell is located, and the second node may be an AMF.

Step 401A: the first node transmits a first message to the UE, which contains information related to on-demand SIB1 transmission. The first message may be included in one or more of the following: master information block (MIB), SIB1, radio resource control (RRC) message, medium access control control element (MAC CE), etc. The RRC message may include one or more of the following: RRC release message, RRC establishment message, RRC reestablishment message, RRC reconfiguration message, RRC resume message, paging message, etc. The first message may include one or more of the following fields and/or related information:
transmitting node of an uplink wake-up signal configuration: used to inform the transmitting node of an uplink wake-up signal configuration. After receiving this information, the UE may receive a configuration of an uplink wake-up signal from the transmitting node of the uplink wake-up signal. The transmitting node of an uplink wake-up signal configuration may include one or more of the following: a gNB DU where an energy-saving cell is located, a gNB CU where an energy-saving cell is located, a node where an energy-saving cell is located, a gNB DU where a normal cell is located, a gNB CU where a normal cell is located, a node where a normal cell is located, cell identification of a normal cell, cell identification of an energy-saving cell, etc.
transmitting cell of an uplink wake-up signal configuration: used to inform the transmitting cell of an uplink wake-up signal configuration. After receiving this information, the UE may receive a configuration of an uplink wake-up signal from the transmitting cell of the uplink wake-up signal. The transmitting cell of the uplink wake-up signal configuration may include one or more of the following: energy-saving cell (identification and/or identification list), normal cell (identification and/or identification list), and cell identification and/or identification list.
UE corresponding to an uplink wake-up signal configuration: used to inform the UE corresponding to an uplink wake-up signal configuration. The information of the UE corresponding to an uplink wake-up signal configuration may include one or more of the following: UE identification and/or identification list.
receiving node of an uplink wake-up signal: used to inform the receiving node of an uplink wake-up signal. After receiving this information, the UE may transmit an uplink wake-up signal to the receiving node of the uplink wake-up signal. The receiving node of the uplink wake-up signal may include one or more of the following: a gNB DU where an energy-saving cell is located, a gNB CU where an energy-saving cell is located, a node where an energy-saving cell is located, a gNB DU where a normal cell is located, a gNB CU where a normal cell is located, a node where a normal cell is located, cell identification of a normal cell, cell identification of an energy-saving cell, etc.
receiving cell of an uplink wake-up signal: used to inform the receiving cell of an uplink wake-up signal. After receiving this information, the UE may transmit an uplink wake-up signal to the receiving cell of the uplink wake-up signal. The receiving cell of the uplink wake-up signal may include one or more of the following: energy-saving cell (identification and/or identification list), normal cell (identification and/or identification list), and cell identification and/or identification list.
transmission mode of an uplink wake-up signal configuration: used to inform the transmission mode of an uplink wake-up signal configuration. After receiving this information, the UE may receive the configuration of the uplink wake-up signal according to the corresponding transmission mode. The transmission mode may include one or more of the following: unicast, multicast and broadcast. For example, the unicast may refer to transmission by using an RRC message and/or MAC CE. For example, the broadcast may refer to transmission by using a broadcast message.
transmission message of an uplink wake-up signal configuration: used to inform the message used for transmitting the uplink wake-up signal configuration. The message may contain one or more of the following: MIB, SIB1, RRC message, MAC CE, etc. The RRC message may include one or more of the following: RRC release message, RRC establishment message, RRC reestablishment message, RRC reconfiguration message, RRC resume message, paging message, etc.
transmitting node of SIB1: used to inform the transmitting node of SIB1. After receiving this information, the UE may receive SIB1 from the transmitting node of SIB1. The transmitting node of SIB1 may include one or more of the following: a gNB DU where an energy-saving cell is located, a gNB CU where an energy-saving cell is located, a node where an energy-saving cell is located, a gNB DU where a normal cell is located, a gNB CU where a normal cell is located, a node where a normal cell is located, cell identification of a normal cell, cell identification of an energy-saving cell, etc.
transmitting cell of SIB1: used to inform the transmitting cell of SIB1. After receiving this information, the UE may receive SIB1 from the transmitting cell of SIB1. The transmitting cell of SIB1 may include one or more of the following: energy-saving cell (identification and/or identification list), normal cell (identification and/or identification list), and cell identification and/or identification list.
transmission mode of SIB1: used to inform the transmission mode of SIB1. After receiving this information, the UE may receive SIB1 according to the corresponding transmission mode. The transmission mode may include one or more of the following: unicast, multicast and broadcast. For example, the unicast may refer to transmission by using an RRC message and/or MAC CE. For example, the broadcast may refer to transmission by using a broadcast message.
transmission message of SIB1: used to inform the message used for transmitting SIB1. The message may contain one or more of the following: MIB, SIB1, RRC message, MAC CE, etc. The RRC message may include one or more of the following: RRC release message, RRC establishment message, RRC reestablishment message, RRC reconfiguration message, RRC resume message, paging message, etc.
information related to whether on-demand SIB1 is supported.
identification and/or identification list of cells that support on-demand SIB1.
information related to whether on-demand SSB is supported.
identification and/or identification list of cells that support on-demand SSB.

Step 402A: the first node and/or the second node transmits an uplink wake-up signal configuration to the UE. It may be transmitted through Mode A and/or Mode B.

### Mode A:

Step 402A.a1: the first node transmits a second message containing an uplink wake-up signal configuration to the second node. In this step, the second message may be included in one or more of the following: a gNB DU configuration update message, a gNB CU configuration update confirmation/acknowledge message, an F1 setup request message, etc. The second message may include one or more of the following fields and/or related information:
cell identification: used to identify a cell corresponding to the uplink wake-up signal configuration. It is used to inform the cell which can be waked up by the uplink wake-up signal configuration. The cell identification may be a physical cell identification or a GCI.
preamble for wake-up. In an embodiment, after receiving this information, the UE transmits a preamble for requesting wake-up to the node. According to the preamble, the node can know that the preamble is used for requesting the node to perform wake-up, and the node can set an energy-saving strategy based on the preamble for wake-up. For example, the node may return from an energy-saving state to a non-energy-saving state.
preamble for requesting SIB1. In an embodiment, after receiving this information, the UE transmits a preamble for requesting SIB1 to the node. According to the preamble, the node can know that the preamble is used for requesting SIB1, and the node may transmit SIB1 information to the UE as requested later.
preamble for requesting SSB. In an embodiment, after receiving this information, the U E transmits a preamble for requesting SSB to the node. According to the preamble, the node can know that the preamble is used for requesting SSB, and the node may transmit SSB as requested later.
information of resources for transmitting the preamble for wake-up: it may include frequency information, time information, RACH configuration, RACH Occasion (RO), etc.
RACH configuration.
RACH Occasion (RO) configuration.
transmission message of an uplink wake-up signal: used to inform the message used for transmitting the uplink wake-up signal. The message may include one or more of the following: preamble, Message 3 (Msg 3) of a random access process, RRC message, MAC CE, etc. The RRC message may include one or more of the following: RRC release request message, RRC establishment request message, RRC reestablishment request message, RRC reconfiguration request message, RRC resume request message, RRC release complete message, RRC establishment complete message, RRC reestablishment complete message, RRC reconfiguration complete message, RRC resume complete message, etc. After receiving this information, the UE can use the transmission message to transmit the uplink wake-up signal.
purpose of transmitting an uplink wake-up signal configuration: used to indicate the purpose of transmitting an uplink wake-up signal configuration. The purpose may include one or more of the following: it is used as reference information, it is used for uplink wake-up signal configuration settings, and it may be transmitted to a user, etc. If it is used as reference information, the message receiving node takes this information into account when setting its own configuration. If it is used for uplink wake-up signal configuration settings, the message receiving node this information into account when setting an uplink wake-up signal configuration, for example, setting an uplink wake-up signal configuration which is different from the received uplink wake-up signal configuration to avoid conflict, or setting an uplink wake-up signal configuration which is the same as the received uplink wake-up signal configuration to realize that the same uplink wake-up signal is used by multiple cells. If it may be transmitted to a user, the message receiving node may need to transmit the received uplink wake-up signal configuration to the user, so that the user can wake up a node by using the uplink wake-up signal.
purpose of an uplink wake-up signal: which indicates the purpose of an uplink wake-up signal. For example, it may include one or more of the following: for requesting a node to wake up from an energy-saving state, for requesting SIB1 information (in an embodiment, for example, the requesting SIB1 information may be to request a node and/or cell to transmit (on-demand) SIB1), for requesting a node to transmit SIB1 normally, requesting a node to decrease SIB1 transmission period, requesting a node to increase SIB1 transmission period, requesting a node to transmit SSB, requesting a node to activate SSB, requesting a node to transmit SSB normally, requesting a node to decrease SSB (burst set) period, and requesting a node to increase SSB (burst set) period. In some embodiments, wake-up signals with different purposes correspond to different preambles.
receiving node of an uplink wake-up signal: used to inform the receiving node of an uplink wake-up signal. After receiving this information, the UE may transmit an uplink wake-up signal to the receiving node of the uplink wake-up signal. The receiving node of the uplink wake-up signal may include one or more of the following: a gNB DU where an energy-saving cell is located, a gNB CU where an energy-saving cell is located, a node where an energy-saving cell is located, a gNB DU where a normal cell is located, a gNB CU where a normal cell is located, a node where a normal cell is located, cell identification of a normal cell, cell identification of an energy-saving cell, etc.
receiving cell of an uplink wake-up signal: used to inform the receiving cell of an uplink wake-up signal. After receiving this information, the UE may transmit an uplink wake-up signal to the receiving cell of the uplink wake-up signal. The receiving cell of the uplink wake-up signal may include one or more of the following: energy-saving cell (identification and/or identification list) and normal cell (identification and/or identification list).
information of the time when wake-up can be performed: used to indicate the information of the time when the node can be waked up from an energy-saving state by an uplink wake-up signal, and/or, the time when the node can be requested to transmit SIB1 information by an uplink wake-up signal. For example, the uplink wake-up signal can be transmitted only within the time indicated by the time information.
information of the time when wake-up cannot be performed: used to indicate the information of the time when the node cannot be waked up from an energy-saving state by an uplink wake-up signal, and/or, the time when the node cannot be requested to transmit SIB1 information by an uplink wake-up signal. For example, the uplink wake-up signal cannot be transmitted within the time indicated by the time information.
start identification: used to indicate the start of waking up the node from an energy-saving state by an uplink wake-up signal, and/or the start of requesting the node to transmit SIB1 information.
end identification: used to indicate the end of waking up the node from an energy-saving state by an uplink wake-up signal, and/or the end of requesting the node to transmit SIB1 information.
information of the time for retransmission of an uplink wake-up signal: it indicates that after a user transmits an uplink wake-up signal, if SIB1 information is not obtained within the time in this time information, the uplink wake-up signal can be retransmitted. Alternatively, when a user fails to transmit an uplink wake-up signal, and/or fails to receive SIB1 information after transmitting the uplink wake-up signal, it may retransmit the uplink wake-up signal after the time in this time information. Alternatively, the uplink wake-up signal may be retransmitted only within the time indicated by this time information, and the uplink wake-up signal may not be retransmitted outside of the time indicated by this time information.
maximum number of times of the transmission of an uplink wake-up signal: it indicates that when the number of times of the transmission of an uplink wake-up signal by a user is equal to and/or greater than the maximum number, the user stops transmitting the uplink wake-up signal to the cell. For example, it means that when the number of times of the transmission of an uplink wake-up signal by a user is equal to and/or greater than the maximum number, the user may no longer transmit the uplink wake-up signal to the cell, and may transmit an uplink wake-up signal corresponding to another cell to the other cell.
information of time for activating other cells: in an embodiment, for example, when SIB1 information of a cell corresponding to an uplink wake-up signal cannot be obtained within the time indicated by the time information, an uplink wake-up signal corresponding to another cell is transmitted to wake up the other cell outside the time indicated by the time information. In another embodiment, for example, within the time indicated by the time information, an uplink wake-up signal corresponding to another cell is transmitted to the other cell to wake up the other cell.

Optionally, the second node may transmit a confirmation/acknowledge message to the first node to confirm the reception of the uplink wake-up signal configuration.

Step 402A.a2: the second node transmits a second message containing an uplink wake-up signal configuration to the UE. In this step, the second message may be included in one or more of the following: RRC release message, RRC establishment message, RRC reestablishment message, RRC reconfiguration message, RRC resume message, etc. Information contained in the second message may refer to the second message mentioned before.

### Mode B:

Step 402A.b: the second node transmits a second message containing an uplink wake-up signal configuration to the UE. In this step, the second message may be included in one or more of the following: MIB, SIB1, MAC CE, paging message, broadcast message, etc. Information contained in the second message may refer to the second message mentioned before. This step may also be that the second node transmits a second message containing an uplink wake-up signal configuration to the UE through the first node. For example, the second message may be included in one or more of the following: MIB, SIB1, and a broadcast message, and the second message may be transmitted by the second node to the UE through the first node. This step may also be that the first node transmits a second message containing an uplink wake-up signal configuration to the UE.

Step 403A: the U E transmits a third message containing an uplink wake-up signal to the first node according to the received uplink wake-up signal configuration. Herein, the uplink wake-up signals may include an uplink wake-up signal used for obtaining SIB1 information of an energy-saving cell and/or any other cell. In this step, the third message may be included in one or more of the following: a preamble. In an embodiment, the preamble may be a preamble for requesting SIB1. The third message may include one or more of the following fields and/or related information:
cell identification: used to identify a cell requested to be waked up, for example, a cell requested for SIB1, or a cell requested for SSB. The cell identification may be a physical cell identification or a GCI.
preamble for requesting SIB1.
purpose of an uplink wake-up signal: which indicates the purpose of an uplink wake-up signal. For example, it may include one or more of the following: for requesting a node to wake up from an energy-saving state, for requesting SIB1 information (in an embodiment, for example, the requesting SIB1 information may be to request a node and/or cell to transmit (on-demand) SIB1), for requesting a node to transmit SIB1 normally, requesting a node to decrease SIB1 transmission period, requesting a node to increase SIB1 transmission period, requesting a node to transmit SSB, requesting a node to activate SSB, requesting a node to transmit SSB normally, requesting a node to decrease SSB (burst set) period, and requesting a node to increase SSB (burst set) period. In some embodiments, wake-up signals with different purposes correspond to different preambles, and the message receiving node can determine corresponding purposes according to the preambles.
requested transmission period: it indicates a requested transmission period. It may be a transmission period of SIB1.
period of requested SSB (burst set): it indicates the period of the requested SSB (burst set).

Step 404A: the first node or the second node transmits SIB1 information of an energy-saving cell to the UE. It may be transmitted in Mode X and/or Mode Y.

### Mode X:

Step 404A.x: the first node transmits SIB1 information of an energy-saving cell to the UE. The SIB1 information may be transmitted by means of SIB1 broadcast or by means of MAC CE.

### Mode Y:

Step 404A.y1: the first node transmits a fourth message including a request for SIB1 information transmission to the second node. In this step, the fourth message may be included in one or more of the following: gNB DU configuration update message, gNB CU configuration update confirmation/acknowledge message, F1 setup request message, etc. The fourth message may include one or more of the following fields and/or related information: SIB1 information (of an energy-saving cell), user ID and/or ID list corresponding to the SIB1 to be transmitted, cell ID and/or ID list corresponding to the SIB1 to be transmitted, and cell ID of an energy-saving cell.

Optionally, the second node may transmit a confirmation/acknowledge message to the first node to confirm the reception of the transmission request of SIB1, and/or to confirm whether the transmission of SIB1 can be performed according to the request.

Step 404A.y2: the second node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc. The SIB1 information may also be transmitted through a broadcast message.

FIG. 4B illustrates a method for supporting network energy-saving according to embodiments of the disclosure. Specifically, FIG. 4B shows a process of exchanging on-demand SIB1 related information between nodes, so that the UE can request a node to transmit SIB1 information. For example, in an embodiment, for example, the first node may be a gNB DU where an energy-saving cell is located, and the second node may be a gNB CU where an energy-saving cell is located. In another embodiment, for example, the first node may be a gNB where an energy-saving cell is located, and the second node may be an AMF.

Steps 401B to 402B refer to steps 401A to 402A in FIG. 4A.

Step 403B: the UE transmits a preamble to the first node.

Step 404B: the first node transmits a random access response to the UE.

Step 405B: the UE transmits a third message including an uplink wake-up signal to the second node. In this step, the third message may be transmitted through an RRC message. The RRC message may include one or more of the following: RRC release request message, RR C establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 406B: the first node or the second node transmits SIB1 information of an energy-saving cell to the UE. It may be transmitted through Mode I and/or Mode J and/or Mode K.

### Mode I:

Step 406B.i1: optionally, the second node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. The fifth message may include one or more of the following fields and/or related information:
transmitting node of SIB1: used to inform the transmitting node of SIB1. After receiving this information, the UE may receive SIB1 from the transmitting node of SIB1. The transmitting node of SIB1 may include one or more of the following: a gNB DU where an energy-saving cell is located, a gNB CU where an energy-saving cell is located, a node where an energy-saving cell is located, a gNB DU where a normal cell is located, a gNB CU where a normal cell is located, a node where a normal cell is located, cell identification of a normal cell, cell identification and/or identification list, etc.
UE corresponding to SIB1 information: used to inform the UE corresponding to SIB1 information. The information of the UE corresponding to SIB1 information may include one or more of the following: UE identification and/or identification list.
transmission mode of SIB1: used to inform the transmission mode of SIB1. After receiving this information, the UE may receive SIB1 according to the corresponding transmission mode. The transmission mode may include one or more of the following: unicast, multicast and broadcast. For example, the unicast may refer to transmission by using an RRC message and/or MAC CE. For example, the broadcast may refer to transmission by using a broadcast message.
transmission message of SIB1: used to inform the message used for transmitting SIB1. The message may contain one or more of the following: MIB, SIB1, RRC message, MAC CE, broadcast message, etc. The RRC message may include one or more of the following: RRC release message, RRC establishment message, RRC reestablishment message, RRC reconfiguration message, RRC resume message, paging message, etc.

Step 406B.i2: the second node transmits a fourth message including a request for SIB1 information transmission to the first node. In this step, the fourth message may be included in one or more of the following: gNB CU configuration update message, gNB DU configuration update confirmation/acknowledge message, F1 setup request response, system information transmission command message, etc. Information contained in the fourth message may refer to the mentioned fourth message.

Optionally, the first node may transmit a confirmation/acknowledge message to the second node to confirm the reception of the SIB1 information transmission request, and/or to confirm whether SIB1 information may be transmitted according to the request.

Step 406B.i3: the first node transmits SIB1 information of an energy-saving cell to the UE. The SIB1 information may be transmitted by means of SIB1 broadcast or by means of MAC CE.

### Mode J:

Step 406B.j1: optionally, the second node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. Information contained in the fifth message may refer to the mentioned fifth message.

Step 406B.j2: the second node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc. The SIB1 information may also be transmitted through a broadcast message.

### Mode K:

Step 406B.k: the second node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc. For example, the SIB1 information may be included in Message 4 (Msg 4) of a random access process.

FIG. 4C illustrates a method for supporting network energy-saving according to embodiments of the disclosure. Specifically, FIG. 4C shows a process of exchanging uplink wake-up signal configuration related information among nodes, so that the nodes can set their own uplink wake-up signal configuration based on the uplink wake-up signal configuration related information of neighboring cells.

Step 401C: gNB1-DU transmits a second message containing an uplink wake-up signal configuration to gNB1-CU. In this step, the second message may be included in one or more of the following: a gNB DU configuration update message, a gNB CU configuration update confirmation/acknowledge message, an F1 setup request message, etc. The second message may refer to the mentioned second message.

Step 402C: gNB1-CU transmits a second message containing an uplink wake-up signal configuration to gNB2-CU. In this step, the second message may be included in one or more of the following: NG-RAN node configuration update message, NG-RAN node configuration update confirmation/acknowledge message, X n setup request message, X n setup request response message, etc. The second message may refer to the mentioned second message.

Step 403C: gNB2-CU transmits a second message containing an uplink wake-up signal configuration to gNB2-DU. In this step, the second message may be included in one or more of the following: gNB CU configuration update message, gNB DU configuration update confirmation/acknowledge message, F1 setup request response message, etc. The second message may refer to the mentioned second message.

Step 404C: gNB 2-DU sets an uplink wake-up signal configuration based on the received uplink wake-up signal configuration of the neighboring cell, for example, set it to be a different configuration from the received uplink wake-up signal configuration of the neighboring cell to avoid conflict, or set it to be the same configuration as the received uplink wake-up signal configuration of the neighboring cell to realize the usage of the same uplink wake-up signal by multiple cells.

Step 405C: gNB2-DU transmits an uplink wake-up signal configuration confirmation/acknowledge message to gNB2-CU.

Step 406C: gNB2-CU transmits an uplink wake-up signal configuration confirmation/acknowledge message to gNB1-CU.

Step 407C: gNB1-CU transmits an uplink wake-up signal configuration confirmation/acknowledge message to gNB1-DU.

FIG. 4D illustrates a method for supporting network energy-saving according to embodiments of the disclosure. Specifically, FIG. 4D shows a process of exchanging uplink wake-up signal configuration related information among nodes, so that the nodes can set their own uplink wake-up signal configuration based on the uplink wake-up signal configuration related information of neighboring cells.

Step 401D: gNB1-DU transmits a second message containing an uplink wake-up signal configuration (for example, it may be a first uplink wake-up signal configuration related to gNB1-DU and/or its cell) to gNB1-CU. In this step, the second message may be included in one or more of the following: a gNB DU configuration update message, a gNB CU configuration update confirmation/acknowledge message, an F1 setup request message, etc. The second message may refer to the mentioned second message.

Step 402D: gNB1-CU transmits a second message containing the uplink wake-up signal configuration (for example, it may be the first uplink wake-up signal configuration related to gNB1-DU and/or its cell) to gNB2-CU. For distinction, the second message here may also be called a twenty-fourth message. In this step, the second message may be included in one or more of the following: NG-RAN node configuration update message, NG-RAN node configuration update confirmation/acknowledge message, X n setup request message, X n setup request response message, etc. The second message may refer to the mentioned second message.

Step 403D: gNB2-DU transmits a second message (also called a 21st message for differentiation) containing an uplink wake-up signal configuration (for example, it may be a second uplink wake-up signal configuration related to gNB2-DU and/or its cell) to gNB2-CU. In this step, the second message may be included in one or more of the following: a gNB DU configuration update message, a gNB CU configuration update confirmation/acknowledge message, an F1 setup request message, etc. The second message may refer to the mentioned second message.

Step 404D: gNB2-CU performs conflict detection, for example, detection of whether the uplink wake-up signal configuration of gNB2-DU conflicts with and/or is consistent with the received uplink wake-up signal configuration of neighboring cells (for example, the uplink wake-up signal configuration of gNB1-DU). In some embodiments, for example, if conflicts and/or consistence are detected, the following steps can be performed.

Step 405D: gNB2-CU transmits a sixth message including an uplink wake-up signal configuration update request to gNB2-DU. In this step, the sixth message may be included in one or more of the following: gNB CU configuration update message, gNB DU configuration update confirmation/acknowledge message, F1 setup request response message, etc. The sixth message may include one or more of the following fields and/or related information:
uplink wake-up signal configuration update request: used to indicate a request of update and/or modification of an uplink wake-up signal configuration.
reason/cause for the uplink wake-up signal configuration update request: used to indicate the reason for the request of the update and/or modification of the uplink wake-up signal configuration. The reason/cause may include one or more of the following: conflicting with the uplink wake-up signal configuration of a neighboring cell, and being different from and/or consistent with the uplink wake-up signal configuration of a neighboring cell.
issue of an uplink wake-up signal configuration: the issue may include one or more of the following: conflicting with the uplink wake-up signal configuration of a neighboring cell, and being different from and/or consistent with the uplink wake-up signal configuration of a neighboring cell. The message receiving node may update and/or modify the uplink wake-up signal configuration according to the issue.
suggested uplink wake-up signal configuration: it may be an uplink wake-up signal configuration suggested to be used by the message receiving node. The specific uplink wake-up signal configuration may be one or more of that contained in the second message.
uplink wake-up signal configuration that may be updated: used to inform the message receiving node of the uplink wake-up signal configuration that may be updated and/or modified. The uplink wake-up signal configuration may be one or more of that contained in the second message.

Step 406D: gNB2-DU sets an (updated) uplink wake-up signal configuration based on the received uplink wake-up signal configuration update request, and gNB2-DU transmits a second message including the (updated) uplink wake-up signal configuration to gNB2-CU (for differentiation, it may also be called a 22nd message). In this step, the second message may be included in one or more of the following: a gNB DU configuration update message, a gNB CU configuration update confirmation/acknowledge message, an F1 setup request message, etc. The second message may refer to the mentioned second message.

Step 407D: gNB2-CU transmits an uplink wake-up signal configuration confirmation/acknowledge message to gNB2-DU.

Step 408D: gNB2-CU transmits an uplink wake-up signal configuration confirmation/acknowledge message to gNB1-CU.

Step 409D: gNB1-CU transmits an uplink wake-up signal configuration confirmation/acknowledge message to gNB1-DU.

FIG. 4E illustrates a method for supporting network energy-saving according to embodiments of the disclosure. Specifically, FIG. 4E shows a process of exchanging uplink wake-up signal configuration related information among nodes, so that the nodes can set their own uplink wake-up signal configuration based on the uplink wake-up signal configuration related information of neighboring cells. In an embodiment, for example, the first node may be a gNB or a gNB-CU or a gNB-DU or a gNB CU-CP or a gNB CU-UP or an en-gNB or an eNB or an ng-eNB, and the second node may be a UE. In another embodiment, for example, the first node may be a gNB or a gNB-CU or a gNB-DU or a gNB CU-CP or a gNB CU-UP or an en-gNB or an eNB or an ng-eNB, and the second node may be a gNB or a gNB-CU or a gNB-DU or a gNB CU-CP or a gNB CU-UP or an en-gNB or an eNB or an ng-eNB. In yet another embodiment, for example, the first node may be an AMF or an SMF or an MME, and the second node may be a gNB or a gNB-CU or a gNB CU-CP or an en-gNB or an eNB or an ng-eNB. In yet another embodiment, for example, the first node may be a gNB or a gNB-CU or a gNB CU-CP or an en-gNB or an eNB or an ng-eNB, and the second node may be an AMF or an SMF or an MME.

Step 401E: the first node transmits a second message containing an uplink wake-up signal configuration to the second node. The second message may refer to the mentioned second message.

Step 402E: the second node sets its own uplink wake-up signal configuration based on the received uplink wake-up signal configuration of the neighboring cell, and/or forwards it to other nodes for the other nodes to set an uplink wake-up signal configuration.

Step 402E: optionally, the second node may transmit an uplink wake-up signal configuration confirmation/acknowledge message to the first node. FIG. 4F shows a schematic diagram of an aspect of a method for supporting network energy-saving according to embodiments of the disclosure. Specifically, FIG. 4F shows a process of exchanging uplink wake-up signal configuration related information among nodes, so that the nodes can set their own uplink wake-up signal configuration based on the uplink wake-up signal configuration related information of neighboring cells.

Step 401F: gNB1-DU transmits a second message containing an uplink wake-up signal configuration to gNB1-CU. In this step, the second message may be included in one or more of the following: a gNB DU configuration update message, a gNB CU configuration update confirmation/acknowledge message, an F1 setup request message, etc. The second message may refer to the mentioned second message.

Step 402F: gNB1-CU transmits a second message containing an uplink wake-up signal configuration to gNB2-CU. In this step, the second message may be included in one or more of the following: NG-RAN node configuration update message, NG-RAN node configuration update confirmation/acknowledge message, X n setup request message, X n setup request response message, etc. The second message may refer to the mentioned second message.

Step 403F: gNB2-DU transmits a second message containing an uplink wake-up signal configuration to gNB2-CU. In this step, the second message may be included in one or more of the following: a gNB DU configuration update message, a gNB CU configuration update confirmation/acknowledge message, an F1 setup request message, etc. The second message may refer to the mentioned second message.

Step 404F: gNB2-CU performs conflict detection, for example, detection of whether the uplink wake-up signal configuration of gNB2-DU conflicts with and/or is consistent with the received uplink wake-up signal configuration of neighboring cells (for example, the uplink wake-up signal configuration of gNB1-DU). In some embodiments, for example, if conflicts and/or consistence are detected, the following steps can be performed.

Step 405F: gNB2-CU transmits a sixth message including an uplink wake-up signal configuration update request to gNB1-CU. In this step, the sixth message may be included in one or more of the following: NG-RAN node configuration update message, NG-RAN node configuration update confirmation/acknowledge message, Xn setup request message, Xn setup request response message, etc. Information contained in the sixth message may refer to the mentioned sixth message.

Step 406F: gNB1-CU transmits a sixth message including an uplink wake-up signal configuration update request to gNB2-DU. In this step, the sixth message may be included in one or more of the following: gNB CU configuration update message, gNB DU configuration update confirmation/acknowledge message, F1 setup request response message, etc. Information contained in the sixth message may refer to the mentioned sixth message.

Step 407F: gNB1-DU sets an uplink wake-up signal configuration based on the received uplink wake-up signal configuration update request, and transmits a second message containing the uplink wake-up signal configuration to gNB1-CU. In this step, the second message may be included in one or more of the following: a gNB DU configuration update message, a gNB CU configuration update confirmation/acknowledge message, an F1 setup request message, etc. The second message may refer to the mentioned second message.

Step 408F: gNB1-CU transmits a second message containing an uplink wake-up signal configuration to gNB2-CU. In this step, the second message may be included in one or more of the following: NG-RAN node configuration update message, NG-RAN node configuration update confirmation/acknowledge message, X n setup request message, X n setup request response message, etc. The second message may refer to the mentioned second message.

Step 409F: gNB2-CU transmits an uplink wake-up signal configuration confirmation/acknowledge message to gNB2-DU.

Step 410F: gNB2-CU transmits an uplink wake-up signal configuration confirmation/acknowledge message to gNB1-CU.

Step 411F: gNB1-CU transmits an uplink wake-up signal configuration confirmation/acknowledge message to gNB1-DU.

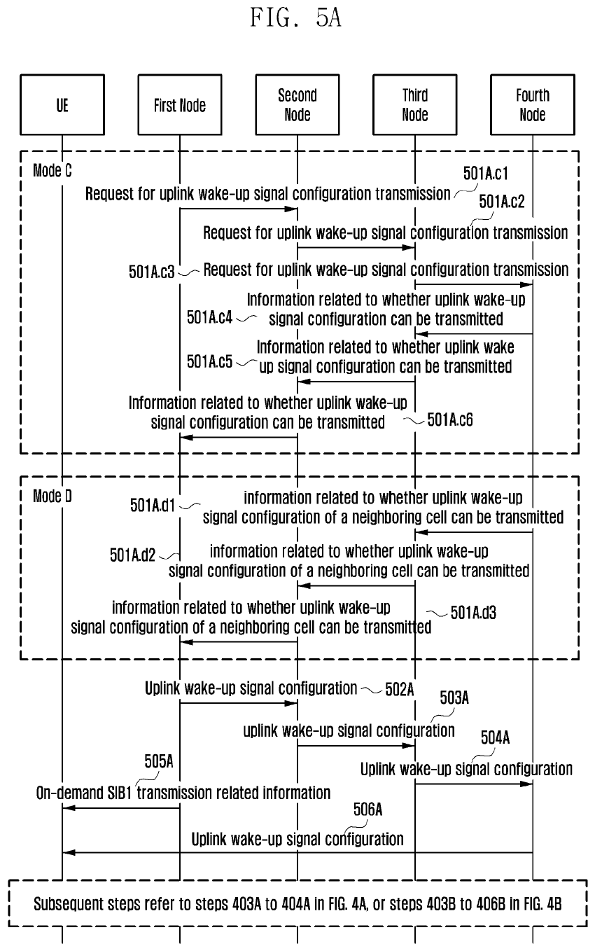

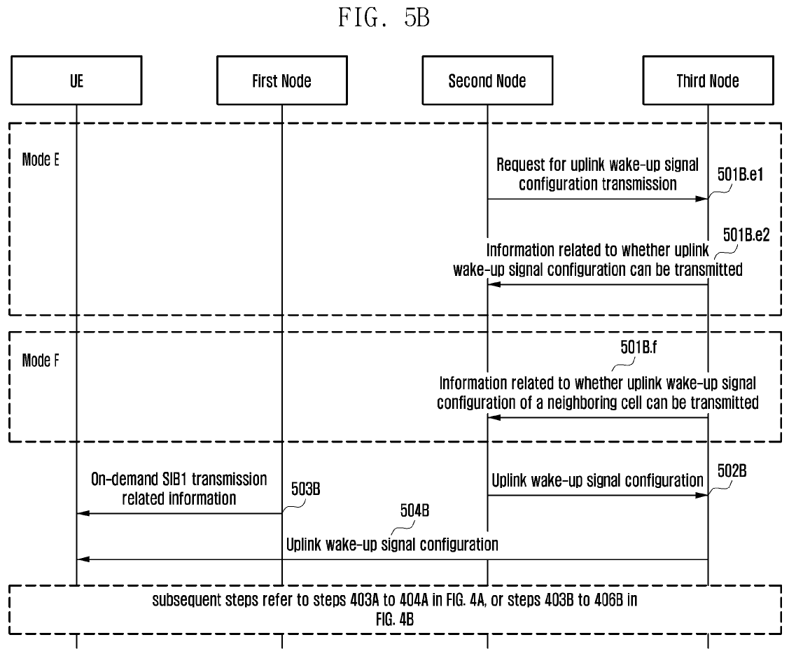

FIG. 5A illustrates a method for supporting network energy-saving according to embodiments of the disclosure. Specifically, FIG. 5A shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Step 501A: nodes exchange information about whether uplink wake-up signal configuration can be transmitted for another cell, which may be implemented by Mode C and/or Mode D. Here, the other cell may be an energy-saving cell.

### Mode C:

Step 501A.c1: the first node transmits a seventh message including a request for uplink wake-up signal configuration transmission to the second node, where the uplink wake-up signal configuration may be used to wake up the first node's own cell or a neighboring cell. In this step, the seventh message may be included in one or more of the following: gNB DU configuration update message, gNB CU configuration update confirmation/acknowledge message, F1 setup request message, etc. The seventh message may include one or more of the following fields and/or related information:
request identification for uplink wake-up signal configuration transmission: used to identify a request for a node to transmit an uplink wake-up signal configuration. The request identification may also be one or more of the following: start, stop, modify and/or update, release, cancel, etc. The “start” indicates that it is requested to start transmitting an uplink wake-up configuration. The “stop” indicates that it is requested to stop transmitting an uplink wake-up configuration. The “modify” and/or “update” indicates that it is requested to modify and/or update an uplink wake-up signal configuration. For example, if it is “stop,” the subsequent transmission of the uplink wake-up signal configuration and subsequent steps thereof may not be performed. For example, if it is “stop,” the subsequent step 502A and subsequent steps thereof may not be performed. The “stop” may also request and/or indicate the message receiving node to release the uplink wake-up signal configuration. For example, the message receiving node releases the uplink signal configuration after receiving the “stop.” The “stop” may also mean cancelling the transmitting of the uplink wake-up signal configuration. For example, the message receiving node cancels the transmitting of the uplink wake-up signal configuration and/or releases the uplink wake-up signal configuration after receiving the “stop.” For example, if this information is “modify” and/or “update,” the message receiving node modifies and/or updates the stored uplink wake-up signal configuration. If this information is “release,” the message receiving node releases the uplink signal configuration. If this information is “cancel,” the message receiving node cancels the transmitting of the uplink wake-up signal configuration, and/or releases the uplink wake-up signal configuration.
transmission time corresponding to the requested uplink wake-up signal configuration transmission: which, for example, may include one or more of the following: immediate transmission, within a time interval, after a time point, before a time point, outside a time interval, etc. In some embodiments, for example, when the information is 0, it means immediate transmission, or when the information is not present, it means immediate transmission.
transmission period corresponding to the requested uplink wake-up signal configuration transmission.
cell identification and/or identification list corresponding to the requested uplink wake-up signal configuration transmission.
UE identification and/or identification list corresponding to the requested uplink wake-up signal configuration transmission.
node identification and/or identification list corresponding to the requested uplink wake-up signal configuration transmission.
transmission mode corresponding to the requested uplink wake-up signal configuration transmission: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the requested uplink wake-up signal configuration transmission: it may include one or more of the following: SIB1, MIB, MAC CE, RRC message, broadcast message, etc.

Step 501A.c2: the second node transmits a seventh message including a request for uplink wake-up signal configuration transmission to the third node, where the uplink wake-up signal configuration may be used to wake up the second node's own cell or a neighboring cell. In this step, the seventh message may be included in one or more of the following: NG-RAN node configuration update message, NG-RAN node configuration update confirmation/acknowledge message, Xn setup request message, Xn setup request response message, etc. Information contained in the seventh message may refer to the mentioned seventh message.

Step 501A.c3: the third node transmits a seventh message including a request for uplink wake-up signal configuration transmission to the fourth node, where the uplink wake-up signal configuration may be used to wake up the third node's own cell or a neighboring cell. In this step, the seventh message may be included in one or more of the following: gNB CU configuration update message, gNB DU configuration update confirmation/acknowledge message, F1 setup request response message, etc. Information contained in the seventh message may refer to the mentioned seventh message.

Step 501A.c4: the fourth node transmits an eighth message to the third node, which contains information related to whether the uplink wake-up signal configuration can be transmitted, where the uplink wake-up signal configuration may be used to wake up the third node's own cell or a neighboring cell. In this step, the eighth message may be included in one or more of the following: gNB DU configuration update message, gNB CU configuration update confirmation/acknowledge message, F1 setup request message, etc. The eighth message may include one or more of the following fields and/or related information:
information of whether an uplink wake-up signal can be transmitted. The information may also indicate whether the uplink wake-up signal configuration can be started and/or stopped and/or modified and/or updated. The “start” indicates that the uplink wake-up configuration transmission is started. The “stop” indicates that the uplink wake-up configuration transmission is stopped. The “modify” and/or “update” indicates that the uplink wake-up configuration transmission is modified and/or updated. For example, if it is “stop,” the subsequent transmission of the uplink wake-up signal configuration and subsequent steps thereof may not be performed. For example, if it is “stop,” the subsequent step 502A and subsequent steps thereof may not be performed. The “stop” may also request and/or indicate the message receiving node to release the uplink wake-up signal configuration. The “stop” may also mean cancelling the transmitting of the uplink wake-up signal configuration.
transmission time corresponding to the uplink wake-up signal configuration transmission that can (not) be performed.
transmission period corresponding to the uplink wake-up signal configuration transmission that can (not) be performed.
identification and/or identification list of energy-saving cells corresponding to the uplink wake-up signal configuration transmission that can (not) be performed.
identification and/or identification list of UEs corresponding to the uplink wake-up signal configuration transmission that can (not) be performed.
identification and/or identification list of nodes where energy-saving cells corresponding to the uplink wake-up signal configuration transmission that can (not) be performed are located.
transmission mode corresponding to the uplink wake-up signal configuration transmission that can (not) be performed: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the uplink wake-up signal configuration transmission that can (not) be performed: it may include one or more of the following: SIB1, MIB, MAC CE, RRC message, broadcast message, etc.
identification and/or identification list of cells which can (not) perform uplink wake-up signal configuration transmission.
identification and/or identification list of nodes which can (not) perform uplink wake-up signal configuration transmission.

Step 501A.c5: the third node transmits an eighth message to the second node, which contains information related to whether the uplink wake-up signal configuration can be transmitted, where the uplink wake-up signal configuration may be used to wake up its own cell or a neighboring cell. In this step, the eighth message may be included in one or more of the following: NG-RAN node configuration update message, NG-RAN node configuration update confirmation/acknowledge message, Xn setup request message, Xn setup request response message, etc. Information contained in the eighth message may refer to the mentioned eighth message.

Step 501A.c6: the second node transmits an eighth message to the first node, which contains information related to whether the uplink wake-up signal configuration can be transmitted, where the uplink wake-up signal configuration may be used to wake up its own cell or a neighboring cell. In this step, the eighth message may be included in one or more of the following: gNB CU configuration update message, gNB DU configuration update confirmation/acknowledge message, F1 setup request response message, etc. Information contained in the eighth message may refer to the mentioned eighth message.

### Mode D:

Step 501A.d1: the fourth node transmits an eighth message to the third node, which contains information related to whether the uplink wake-up signal configuration can be transmitted, where the uplink wake-up signal configuration may be used to wake up its own cell or a neighboring cell. In this step, the eighth message may be included in one or more of the following: gNB DU configuration update message, gNB CU configuration update confirmation/acknowledge message, F1 setup request message, etc. Information contained in the eighth message may refer to the mentioned eighth message.

Step 501A.d2: the third node transmits an eighth message to the second node, which contains information related to whether the uplink wake-up signal configuration can be transmitted, where the uplink wake-up signal configuration may be used to wake up its own cell or a neighboring cell. In this step, the eighth message may be included in one or more of the following: NG-RAN node configuration update message, NG-RAN node configuration update confirmation/acknowledge message, Xn setup request message, Xn setup request response message, etc. Information contained in the eighth message may refer to the mentioned eighth message.

Step 501A.d3: the second node transmits an eighth message to the first node, which contains information related to whether the uplink wake-up signal configuration can be transmitted, where the uplink wake-up signal configuration may be used to wake up its own cell or a neighboring cell. In this step, the eighth message may be included in one or more of the following: gNB CU configuration update message, gNB DU configuration update confirmation/acknowledge message, F1 setup request response message, etc. Information contained in the eighth message may refer to the mentioned eighth message.

Optionally, after receiving the eighth message, the node transmits a confirmation/acknowledge message to the transmitting node of the eighth message to confirm the reception of the eighth message. For example, it may include one or more of the following: the first node transmits a confirmation/acknowledge message to the second node, the second node transmits a confirmation/acknowledge message to the third node, and the third node transmits a confirmation/acknowledge message to the fourth node.

Step 502A: optionally, the first node transmits a second message containing an uplink wake-up signal configuration to the second node. In this step, the second message may be included in one or more of the following: a gNB DU configuration update message, a gNB CU configuration update confirmation/acknowledge message, an F1 setup request message, etc. The second message may refer to the mentioned second message. The second message may also contain the information contained in the seventh message.

Step 503A: optionally, the second node transmits a second message containing an uplink wake-up signal configuration to the third node. In this step, the second message may be included in one or more of the following: NG-RAN node configuration update message, NG-RAN node configuration update confirmation/acknowledge message, Xn setup request message, Xn setup request response message, etc. The second message may refer to the mentioned second message. The second message may also contain the information contained in the seventh message.

Step 504A: optionally, the third node transmits a second message containing an uplink wake-up signal configuration to the fourth node. In this step, the second message may be included in one or more of the following: gNB CU configuration update message, gNB DU configuration update confirmation/acknowledge message, F1 setup request response message, etc. The second message may refer to the mentioned second message. The second message may also contain the information contained in the seventh message. If the fourth node can obtain the uplink wake-up signal configuration by other ways (for example, through OAM configuration, etc.), steps 502A, 503A and 504A may be omitted.

In some embodiments, step 502A can be combined with step 501A.c1, step 503A can be combined with step 501A.c2, and step 504A can be combined with step 501A.c3.

In some embodiments, step 501A.c3 and/or step 501A.c4 may be omitted. If step 501A.c3 and/or step 501A.c4 are omitted, step 506A may be a transmission to UE by a third node. Alternatively, if step 501A.c3 and/or step 501A.c4 are omitted, step 506A may be that the third node adds the uplink wake-up signal configuration received in step 503A into the message and/or information received from the fourth node, and then the third node transmits the second information containing the uplink wake-up signal configuration to the UE. For example, step 506A may be that the third node adds the uplink wake-up signal configuration received in step 503A into a broadcast message received from the fourth node, and then the third node transmits a broadcast message containing the uplink wake-up signal configuration to the UE.

Step 505A: the first node transmits a first message to the UE, which contains information related to on-demand SIB1 transmission. The first message may be included in one or more of the following: MIB, SIB1, MAC CE, broadcast message, etc. Information contained in the first message refers to the first message mentioned. This step is optional. This step may also be a transmission to UE from a second node. This step may also be a transmission to UE from the first node through a second node. For example, the first message is included in one or more of the following: MIB, SIB1, and broadcast message, etc., and the first message may be transmitted to the UE by the first node through a second node.

Step 506A: the fourth node transmits a second message containing an uplink wake-up signal configuration to the UE. In this step, the second message may be included in one or more of the following: MIB, SIB1, MAC CE, paging message, and broadcast message, etc. Information contained in the second message may refer to the second message mentioned before. This step may also be that the fourth node transmits a second message containing an uplink wake-up signal configuration to the UE through a third node. For example, the second message is included in one or more of the following: MIB, SIB1, and broadcast message, etc., and the second message may be transmitted to the UE by the fourth node through a third node. This step may also be that the third node transmits a second message containing an uplink wake-up signal configuration to the UE. Transmission by a fourth node to the UE is shown in the drawings as an example.

The subsequent steps refer to steps 403A to 404A in FIG. 4A, or steps 403B to 406B in FIG. 4B.

Steps 501A.d1 and/or 501A.d2 and/or 501A.d3 may also occur after the subsequent steps (that is, step 502A and the subsequent steps thereof).

FIG. 5B illustrates a method for supporting network energy-saving according to embodiments of the disclosure. Specifically, FIG. 5B shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, and the third node may be a gNB CU of a normal cell or a gNB of a normal cell.

Step 501B: nodes exchange information about whether uplink wake-up signal configuration can be transmitted for another cell, which may be implemented by Mode E and/or Mode F.

### Mode E:

Step 501B.e1: the second node transmits a seventh message including a request for uplink wake-up signal configuration transmission to the third node, where the uplink wake-up signal configuration may be used to wake up its own cell or a neighboring cell. In this step, the seventh message may be included in one or more of the following: NG-RAN node configuration update message, NG-RAN node configuration update confirmation/acknowledge message, Xn setup request message, Xn setup request response message, etc. Information contained in the seventh message may refer to the mentioned seventh message.

Step 501B.e2: the third node transmits an eighth message to the second node, which contains information related to whether the uplink wake-up signal configuration can be transmitted, where the uplink wake-up signal configuration may be used to wake up its own cell or a neighboring cell. In this step, the eighth message may be included in one or more of the following: NG-RAN node configuration update message, NG-RAN node configuration update confirmation/acknowledge message, Xn setup request message, Xn setup request response message, etc. Information contained in the eighth message may refer to the mentioned eighth message.

### Mode F:

Step 501B.f: the third node transmits an eighth message to the second node, which contains information related to whether the uplink wake-up signal configuration can be transmitted, where the uplink wake-up signal configuration may be used to wake up its own cell or a neighboring cell. In this step, the eighth message may be included in one or more of the following: NG-RAN node configuration update message, NG-RAN node configuration update confirmation/acknowledge message, Xn setup request message, Xn setup request response message, etc. Information contained in the eighth message may refer to the mentioned eighth message.

Optionally, the second node may transmit a confirmation/acknowledge message to the third node to acknowledge the reception of the eighth message.

Step 502B: optionally, the second node transmits a second message containing an uplink wake-up signal configuration to the third node. In this step, the second message may be included in one or more of the following: NG-RAN node configuration update message, NG-RAN node configuration update confirmation/acknowledge message, Xn setup request message, Xn setup request response message, etc. The second message may refer to the mentioned second message. The second message may also contain the information contained in the seventh message.

If the third node can obtain the uplink wake-up signal configuration by other ways (for example, through OAM configuration, etc.), step 502B may be omitted.

In some embodiments, step 502B can be combined with step 501B.e1.

Step 503B: the first node transmits a first message to the UE, which contains information related to on-demand SIB1 transmission. The first message may be included in one or more of the following: MIB, SIB1, MAC CE, broadcast message, etc. Information contained in the first message refers to the first message mentioned. This step may also be that the first node transmits a first message which contains information related to on-demand SIB1 transmission to the UE through a second node. For example, the first message is included in one or more of the following: MIB, SIB1, broadcast message, etc., and the first message may be transmitted to the UE by the first node through a second node. This step may also be that the second node transmits a first message which contains information related to on-demand SIB1 transmission to the UE.

Step 504B: the fourth node transmits a second message containing an uplink wake-up signal configuration to the UE. In this step, the second message may be included in one or more of the following: RRC release message, RRC establishment message, RRC reestablishment message, RRC reconfiguration message, RRC resume message, etc. Information contained in the second message may refer to the second message mentioned before.

The subsequent steps refer to steps 403A to 404A in FIG. 4A, or steps 403B to 406B in FIG. 4B.

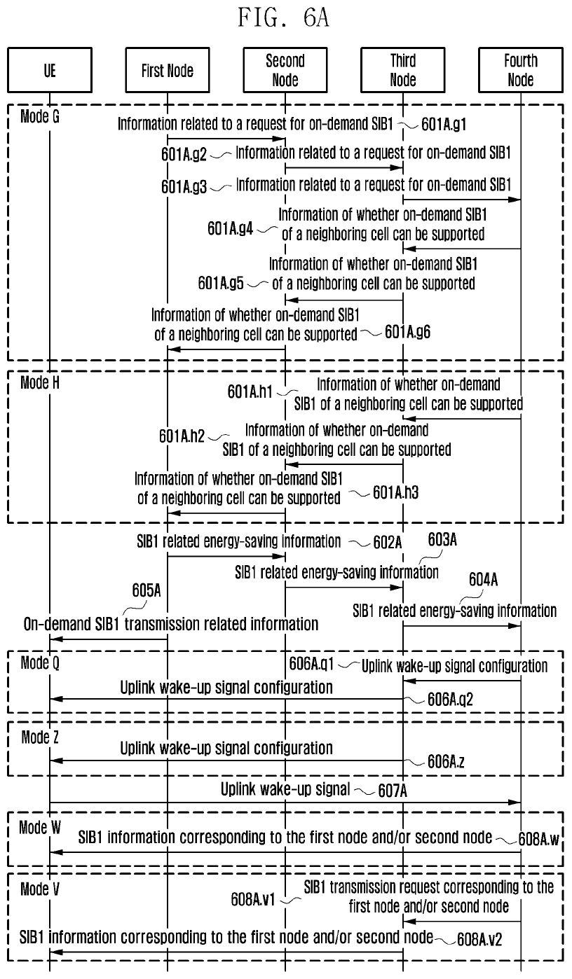

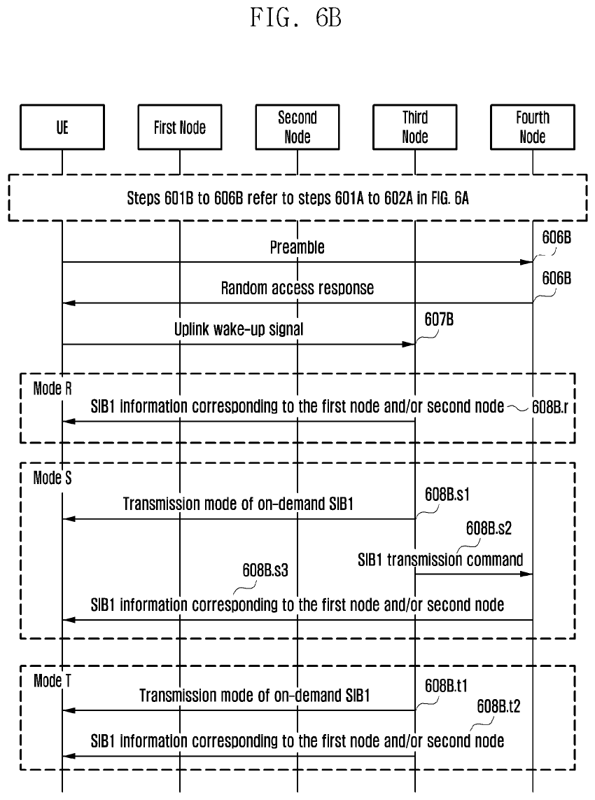

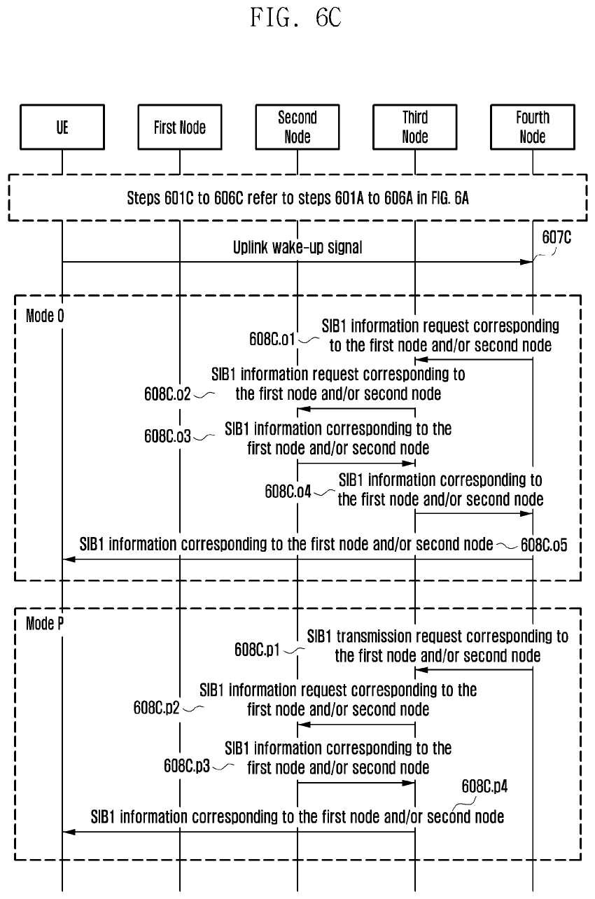

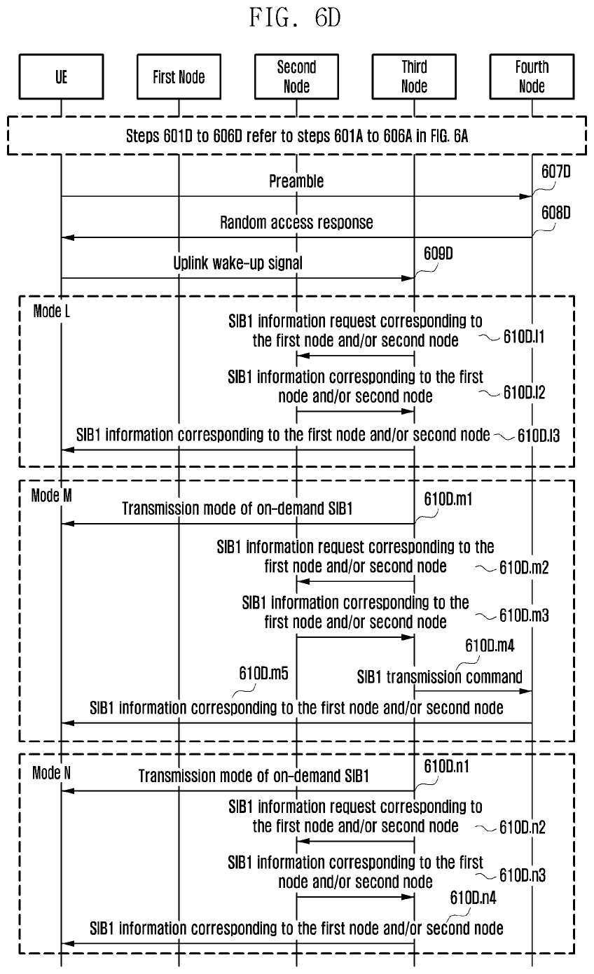

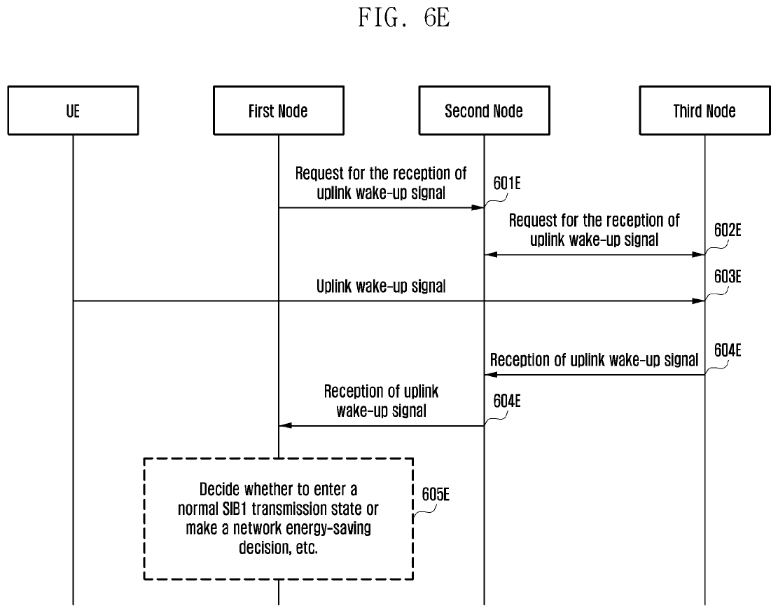

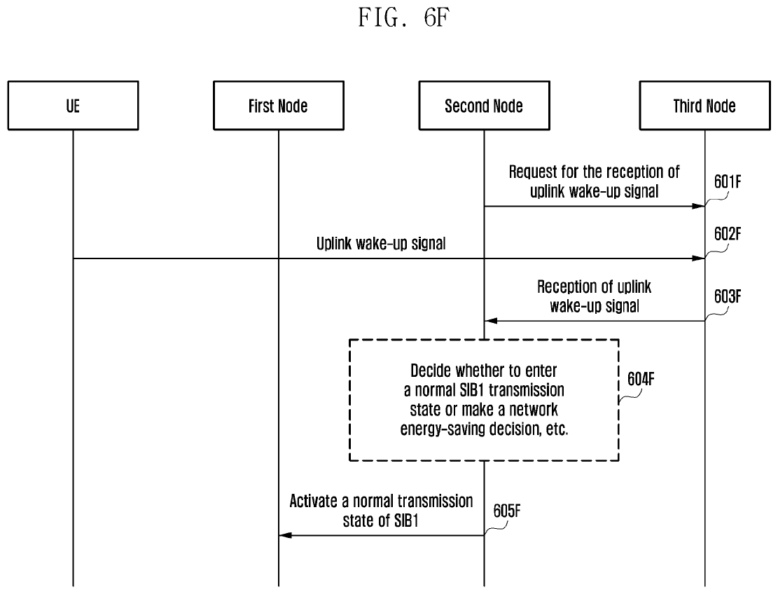

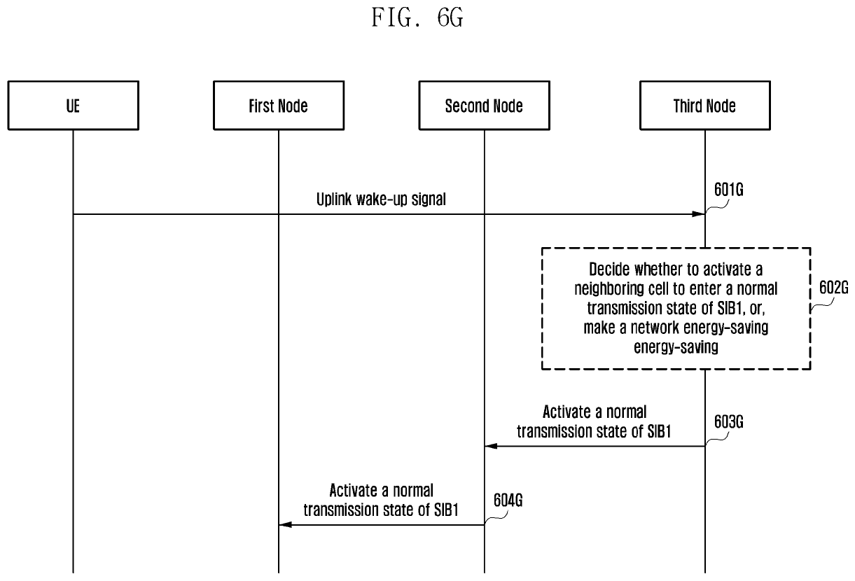

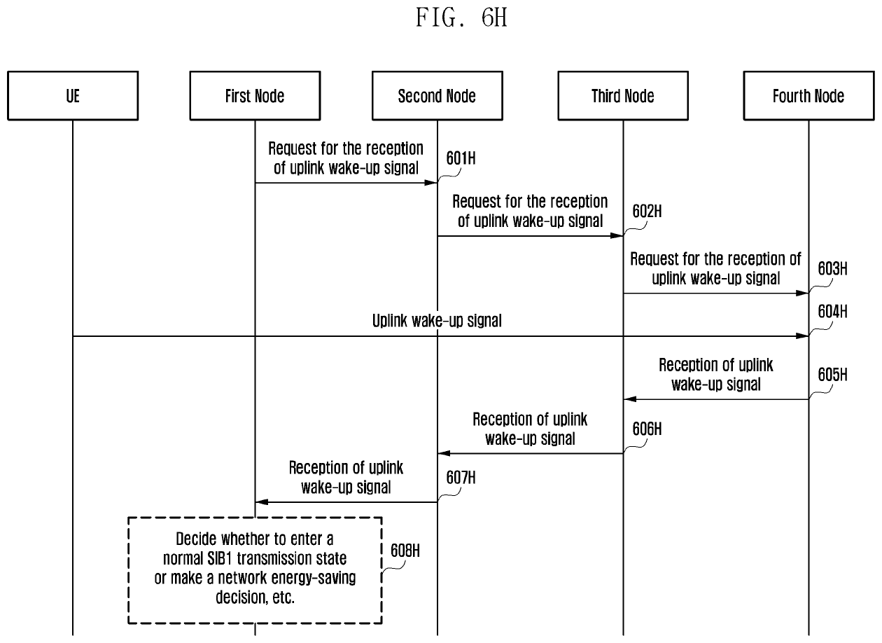

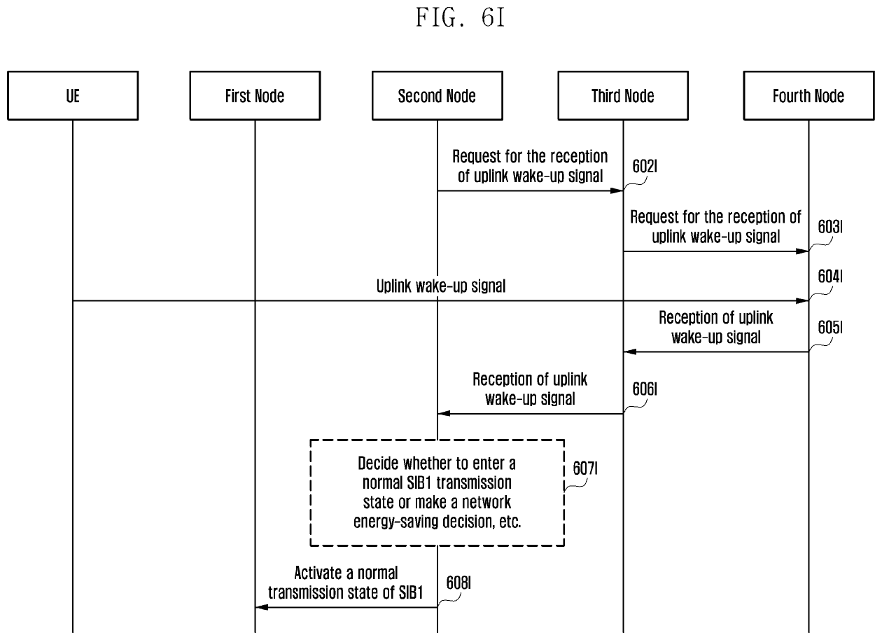

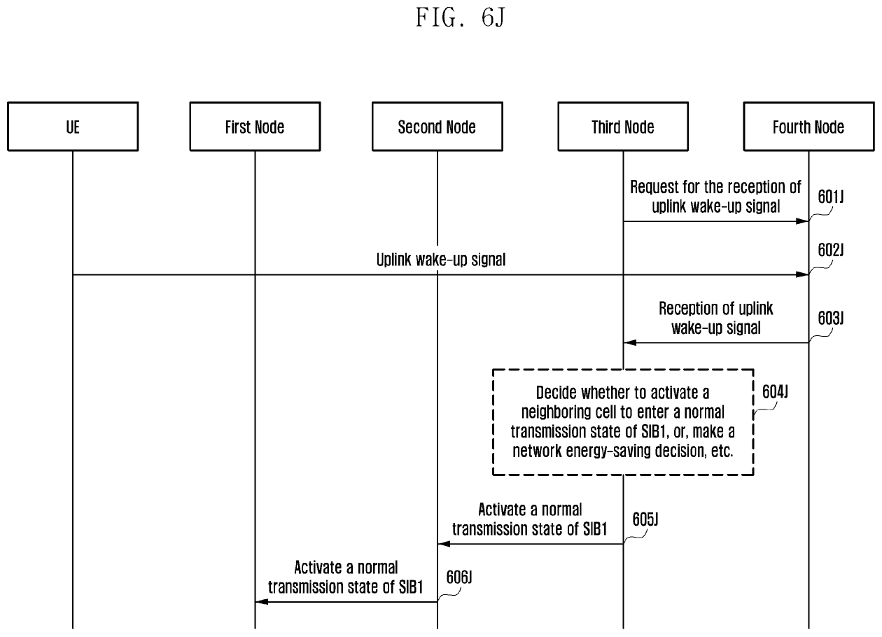

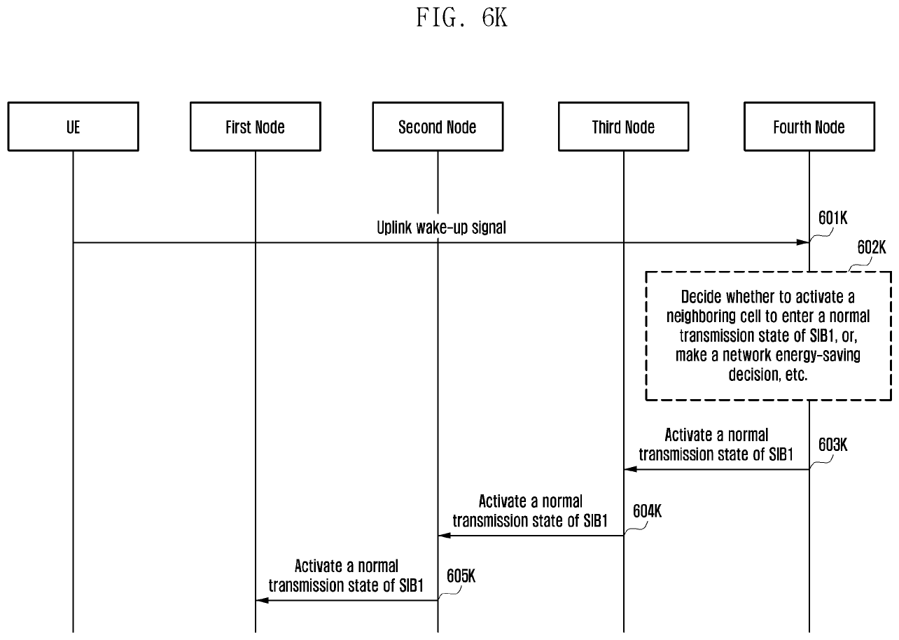

FIG. 6A illustrates a method for supporting network energy-saving according to embodiments of the disclosure. Specifically, FIG. 6A shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell. In other embodiments, for convenience of description, the first node and the second node may also be included in a fifth node (for example, a gNB where an energy-saving cell is located, such as gNB1) together, and the third node and the fourth node may also be included in a sixth node (for example, a gNB where a normal cell is located, such as gNB2) together. In some embodiments, the fifth node may be a neighboring node of the sixth node, and the cell of the fifth node and the cell of the sixth node may also be served as neighboring cells to each other. It should be understood that in other embodiments or drawings of the disclosure, the two nodes exchanging information may also be served as neighboring nodes to each other, and their cells may also be served as nerghboring cells to each other, which may not be described again below.

Step 601A: nodes exchange information about whether uplink wake-up signal configuration can be transmitted for another cell, which may be implemented by Mode G and/or Mode H.

### Mode G:

Step 601A.g1: the first node transmits a ninth message to the second node, which contains information related to a request for on-demand SIB1 (also referred to as information related to a request for supporting an energy-saving cell to perform on-demand SIB1 herein, or referred to as first information). In this step, the first information and/or the ninth message may be included in one or more of the following: gNB DU configuration update message, gNB CU configuration update confirmation/acknowledge message, F1 setup request message, etc. The ninth message may include one or more of the following fields and/or related information:
request identification for uplink wake-up signal configuration setting and/or transmission: used to identify a request for a node to perform uplink wake-up signal configuration setting and/or transmission. The request identification may also include one or more of the following: start, stop, modify and/or update, release, cancel, etc. The “start” indicates that it is requested to start the setting and/or transmission of an uplink wake-up signal configuration. The “stop” indicates that it is requested to stop the setting and/or transmission of an uplink wake-up signal configuration. The “modify” and/or “update” indicates that it is requested to modify and/or update the setting and/or transmission of an uplink wake-up signal configuration. For example, if it is “stop,” the subsequent transmission of SIB1 related energy-saving information and subsequent steps may not be performed. For example, if it is “stop,” the subsequent step 602A and subsequent steps may not be performed. The “stop” may also request and/or indicate the message receiving node to release the uplink wake-up signal configuration. For example, the message receiving node releases the uplink signal configuration after receiving the “stop.” The “stop” may also mean cancelling the transmitting of the uplink wake-up signal configuration. For example, the message receiving node cancels the transmitting of the uplink wake-up signal configuration and/or releases the uplink wake-up signal configuration after receiving the “stop.” For example, if this information is “modify” and/or “update,” the message receiving node modifies and/or updates the stored uplink wake-up signal configuration. If this information is “release,” the message receiving node releases the uplink signal configuration. If this information is “cancel,” the message receiving node cancels the transmitting of the uplink wake-up signal configuration, and/or releases the uplink wake-up signal configuration.
transmission time corresponding to the requested uplink wake-up signal configuration transmission.
transmission period corresponding to the requested uplink wake-up signal configuration transmission.
cell identification and/or identification list corresponding to the requested uplink wake-up signal configuration transmission.
UE identification and/or identification list corresponding to the requested uplink wake-up signal configuration transmission.
node identification and/or identification list corresponding to the requested uplink wake-up signal configuration transmission.
transmission mode corresponding to the requested uplink wake-up signal configuration transmission: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the requested uplink wake-up signal configuration transmission: it may include one or more of the following: SIB1, MIB, MAC CE, RRC message, broadcast message, etc.
request for supporting on-demand SIB1 of an energy-saving cell: a request for supporting on-demand SIB1 of an energy-saving cell.
request for transmitting SIB1 information of an energy-saving cell to UE: used to request a node to transmit SIB1 information of an energy-saving cell to UE.
SIB1 information of an energy-saving cell.
cell identification and/or list of an energy-saving cell.
transmission time corresponding to the requested energy-saving cell SIB1 information transmission.
transmission period corresponding to the requested energy-saving cell SIB1 information transmission.
cell identification and/or identification list corresponding to the requested energy-saving cell SIB1 information transmission.
UE identification and/or identification list corresponding to the requested energy-saving cell SIB1 information transmission.
node identification and/or identification list corresponding to the requested energy-saving cell SIB1 information transmission.
transmission mode corresponding to the requested energy-saving cell SIB1 information transmission: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the requested energy-saving cell SIB1 information transmission: it may include one or more of the following: SIB1, MIB, MAC CE, RRC message, broadcast message, etc.
request for reporting the number of reception times of an uplink wake-up signal.
condition and/or event for reporting the number of reception times of an uplink wake-up signal: when the following conditions and/or events are met, the number of reception times of an uplink wake-up signal is reported:
Condition and/or Event 1: the number of reception times of an uplink wake-up signal is greater than and/or equal to a threshold value. The event and/or condition includes one or more of the following: condition and/or event type, condition and/or event, threshold value, etc.
Condition and/or Event 2: the number of reception times of an uplink wake-up signal within a certain period of time is greater than and/or equal to a threshold value. The event and/or condition includes one or more of the following: condition and/or event type, condition and/or event, threshold value, the time, etc.

Step 601A.g2: the second node transmits a ninth message to the third node, which contains information related to a request for on-demand SIB1. In this step, the ninth message may be included in one or more of the following: NG-RAN node configuration update message, NG-RAN node configuration update confirmation/acknowledge message, X n setup request message, Xn setup request response message, etc. Information contained in the ninth message may refer to the mentioned ninth message.

Step 601A.g3: the third node transmits a ninth message to the fourth node, which contains information related to a request for on-demand SIB1. In this step, the ninth message may be included in one or more of the following: gNB CU configuration update message, gNB DU configuration update confirmation/acknowledge message, F1 setup request response message, etc. Information contained in the ninth message may refer to the mentioned ninth message.

Step 601A.g4: the fourth node transmits a tenth message to the third node, which contains information related to whether on-demand SIB1 of a neighboring cell can be supported. The tenth message may be transmitted in response to the ninth message. In this step, the tenth message may be included in one or more of the following: gNB DU configuration update message, gNB CU configuration update confirmation/acknowledge message, F1 setup request message, etc. The tenth message may include one or more of the following fields and/or related information:
information of whether an uplink wake-up signal configuration can be configured and/or transmitted. The information may also indicate whether the configuration and/or transmission of an uplink wake-up signal configuration can be started, stopped, modified and/or updated, released, cancelled. The “start” indicates to request the setting and/or transmission of an uplink wake-up signal configuration. The “stop” indicates to stop the setting and/or transmission of an uplink wake-up signal configuration. The “modify” and/or “update” indicates to modify and/or update the setting and/or transmission of an uplink wake-up signal configuration. For example, if it is “stop,” the subsequent transmission of SIB1 related energy-saving information and subsequent steps may not be performed. For example, if it is “stop,” the subsequent step 602A and subsequent steps may not be performed. The “stop” may also request and/or indicate the message receiving node to release the uplink wake-up signal configuration. For example, the message receiving node releases the uplink signal configuration after receiving the “stop.” The “stop” may also mean cancelling the transmitting of the uplink wake-up signal configuration. For example, the message receiving node cancels the transmitting of the uplink wake-up signal configuration and/or releases the uplink wake-up signal configuration after receiving the “stop.” For example, if this information is “modify” and/or “update,” the message receiving node modifies and/or updates the stored uplink wake-up signal configuration. If this information is “release,” the message receiving node releases the uplink signal configuration. If this information is “cancel,” the message receiving node cancels the transmitting of the uplink wake-up signal configuration, and/or releases the uplink wake-up signal configuration.
transmission time corresponding to the uplink wake-up signal configuration transmission that can (not) be performed.
transmission period corresponding to the uplink wake-up signal configuration transmission that can (not) be performed.
identification and/or identification list of energy-saving cells corresponding to the uplink wake-up signal configuration transmission that can (not) be performed.
identification and/or identification list of UEs corresponding to the uplink wake-up signal configuration transmission that can (not) be performed.
identification and/or identification list of nodes where energy-saving cells corresponding to the uplink wake-up signal configuration transmission that can (not) be performed are located.
transmission mode corresponding to the uplink wake-up signal configuration transmission that can (not) be performed: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the uplink wake-up signal configuration transmission that can (not) be performed: it may include one or more of the following: SIB1, MIB, MAC CE, RRC message, broadcast message, etc.
identification and/or identification list of cells which can (not) perform uplink wake-up signal configuration transmission.
identification and/or identification list of nodes which can (not) perform uplink wake-up signal configuration transmission.
information of whether on-demand SIB1 of an energy-saving cell can be supported: for example, information of whether on-demand SIB1 of a neighboring cell can be supported.
whether SIB1 information of an energy-saving cell can be transmitted to UE: whether SIB1 information of an energy-saving cell can be transmitted to UE.
SIB1 information of an energy-saving cell corresponding to on-demand SIB1 that can (not) be supported.
cell identification and/or list of an energy-saving cell corresponding to on-demand SIB1 that can (not) be supported.
transmission time corresponding to the transmission of SIB1 information of an energy-saving cell corresponding to on-demand SIB1 that can (not) be supported.
transmission period corresponding to the transmission of SIB1 information of an energy-saving cell corresponding to on-demand SIB1 that can (not) be supported.
cell identification and/or identification list corresponding to the transmission of SIB1 information of an energy-saving cell corresponding to on-demand SIB1 that can (not) be supported.
UE identification and/or identification list corresponding to the transmission of SIB1 information of an energy-saving cell corresponding to on-demand SIB1 that can (not) be supported.
node identification and/or identification list corresponding to the transmission of SIB1 information of an energy-saving cell corresponding to on-demand SIB1 that can (not) be supported.
transmission mode corresponding to the transmission of SIB1 information of an energy-saving cell corresponding to on-demand SIB1 that can (not) be supported: it may include one or more of the following: broadcast, unicast, multicast, etc. Herein, the broadcast may be transmission by means of one or more of the following: SIB1, MIB, a broadcast message, etc. Herein, the unicast and/or multicast may be transmission by means of an MAC CE and/or RRC message, etc.
transmission message corresponding to the transmission of SIB1 information of an energy-saving cell corresponding to on-demand SIB1 that can (not) be supported: it may include one or more of the following: SIB1, MIB, MAC CE, RRC message, broadcast message, etc.

Step 601A.g5: the third node transmits a tenth message to the second node, which contains information related to whether on-demand SIB1 of a neighboring cell can be supported. In this step, the tenth message may be included in one or more of the following: NG-RAN node configuration update message, NG-RAN node configuration update confirmation/acknowledge message, Xn setup request message, Xn setup request response message, etc. Information contained in the tenth message may refer to the mentioned tenth message.

Step 601A.g6: the second node transmits a tenth message to the first node, which contains information related to whether on-demand SIB1 of a neighboring cell can be supported. In this step, the tenth message may be included in one or more of the following: gNB CU configuration update message, gNB DU configuration update confirmation/acknowledge message, F1 setup request response message, etc. Information contained in the tenth message may refer to the mentioned tenth message.

### Mode H:

Step 601A.h1: the fourth node transmits a tenth message to the third node, which contains information related to whether on-demand SIB1 of a neighboring cell can be supported. In this step, the tenth message may be included in one or more of the following: gNB DU configuration update message, gNB CU configuration update confirmation/acknowledge message, F1 setup request message, etc.

Step 601A.h2: the third node transmits a tenth message to the second node, which contains information related to whether on-demand SIB1 of a neighboring cell can be supported. In this step, the tenth message may be included in one or more of the following: NG-RAN node configuration update message, NG-RAN node configuration update confirmation/acknowledge message, Xn setup request message, Xn setup request response message, etc. Information contained in the tenth message may refer to the mentioned tenth message.

Step 601A.h3: the second node transmits a tenth message to the first node, which contains information related to whether on-demand SIB1 of a neighboring cell can be supported. In this step, the tenth message may be included in one or more of the following: gNB CU configuration update message, gNB DU configuration update confirmation/acknowledge message, F1 setup request response message, etc. Information contained in the tenth message may refer to the mentioned tenth message.

Optionally, after receiving the tenth message, the node transmits a confirmation/acknowledge message to the transmitting node of the tenth message to confirm the reception of the tenth message. For example, it may include one or more of the following: the first node transmits a confirmation/acknowledge message to the second node, the second node transmits a confirmation/acknowledge message to the third node, and the third node transmits a confirmation/acknowledge message to the fourth node.

Step 602A: the first node transmits an eleventh message including SIB1 related energy-saving information to the second node. Herein, SIB1 related energy-saving information may include SIB1 related energy-saving information associated with a first node and/or a second node and/or a neighboring node of the first node, and/or one or more cells belonging to these nodes. For example, the SIB1 related energy-saving information may include SIB1 related energy-saving information related to an energy-saving cell included in the first node. In this step, the eleventh message may be included in one or more of the following: gNB DU configuration update message, gNB CU configuration update confirmation/acknowledge message, F1 setup request message, etc. The eleventh message and/or SIB1 related energy-saving information may include one or more of the following fields and/or related information:
cell identification.
identification of that a cell enters (is to enter) an energy-saving state: used to indicate that a cell enters (is to enter) an energy-saving state.
identification that a cell enters (is to enter) on-demand SIB1: used to indicate that a cell enters (is to enter) on-demand SIB1.
time when a cell enters on-demand SIB1: used to indicate the time when a cell enters on-demand SIB1.
identification of a request to start supporting on-demand SIB1: used for requesting a node to support on-demand SIB1 of the cell.
time requested for the supporting of on-demand SIB1: used to indicate the time when a node is requested to support on-demand SIB1 of the cell.
information of whether wake-up is allowed: used to indicate whether a cell is allowed to be waked up after entering an energy-saving state. If it is allowed, in some embodiments, on-demand SIB1 of this cell can be supported.
SIB1 information.

The eleventh message and/or SIB1 related energy-saving information may also include information contained in the ninth message.

Step 603A: the second node transmits an eleventh message including SIB1 related energy-saving information to the third node. In this step, the eleventh message may be included in one or more of the following: NG-RAN node configuration update message, NG-RAN node configuration update confirmation/acknowledge message, Xn setup request message, Xn setup request response message, etc. The eleventh message may refer to the mentioned eleventh message. The eleventh message and/or SIB1 related energy-saving information may also include information contained in the ninth message.

Step 604A: the third node transmits an eleventh message including SIB1 related energy-saving information to the fourth node. In this step, the eleventh message may be included in one or more of the following: gNB CU configuration update message, gNB DU configuration update confirmation/acknowledge message, F1 setup request response message, etc. The eleventh message may refer to the mentioned eleventh message. The eleventh message and/or SIB1 related energy-saving information may also include information contained in the ninth message.

If the fourth node can obtain SIB1 related energy-saving information by other ways (for example, through OA M configuration, etc.), steps 602A, 603A and 604A may be omitted.

In some embodiments, step 602A can be combined with step 601A.g1, step 603A can be combined with step 601A.g2, and step 604A can be combined with step 601A.g3.

Step 605A: the first node transmits a first message to the UE containing information related to on-demand SIB1 transmission (for example, it may be information related to on-demand SIB1 transmission of an energy-saving cell in the first node). The first message may be included in one or more of the following: MIB, SIB1, MAC CE, broadcast message, etc. Information contained in the first message refers to the first message mentioned. This step may be that the first node transmits a first message which contains information related to on-demand SIB1 transmission to the UE through a second node. For example, the first message is included in one or more of the following: MIB, SIB1, broadcast message, etc., and the first message may be transmitted to the UE by the first node through a second node. This step may also be that the second node transmits a first message which contains information related to on-demand SIB1 transmission to the UE.

Step 606A: the third node and/or the fourth node transmits an uplink wake-up signal configuration to the UE. The uplink wake-up signal configuration may include an uplink wake-up signal configuration related to an energy-saving cell in the first node. It may be implemented by Mode Q and/or Mode Z.

### Mode Q:

Step 606A.q1: the fourth node transmits a second message containing an uplink wake-up signal configuration to the third node. In this step, the second message may be included in one or more of the following: a gNB DU configuration update message, a gNB CU configuration update confirmation/acknowledge message, an F1 setup request message, etc. The second message may refer to the mentioned second message.

Optionally, the third node may transmit a confirmation/acknowledge message to the fourth node to confirm the reception of the uplink wake-up signal configuration.

Step 606A.q2: the third node transmits a second message containing an uplink wake-up signal configuration to the UE. In this step, the second message may be included in one or more of the following: RRC release message, RRC establishment message, RRC reestablishment message, RRC reconfiguration message, RRC resume message, etc. Information contained in the second message may refer to the second message mentioned before. Herein, the uplink wake-up signal configuration may be used to configure and/or transmit an uplink wake-up signal, for example, an uplink wake-up signal used for obtaining SIB1 information of an energy-saving cell. For the purpose of differentiation, the uplink wake-up signal configuration included in the second message in steps 606A.q2 and/or 606A.z, etc. may also be referred to as a third uplink wake-up signal configuration.

### Mode Z:

Step 606A.z: the fourth node transmits a second message containing an uplink wake-up signal configuration to the UE. In this step, the second message may be included in one or more of the following: MIB, SIB1, MAC CE, paging message, broadcast message, etc. Information contained in the second message may refer to the second message mentioned before. This step may also be that the fourth node transmits a second message containing an uplink wake-up signal configuration to the UE through a third node. For example, the second message is included in one or more of the following: MIB, SIB1, broadcast message, etc., and the second message may be transmitted to the UE by the fourth node through a third node. This step may also be that the third node transmits a second message containing an uplink wake-up signal configuration to the UE. Transmission by a fourth node to the UE is shown in the drawings as an example.

Step 607A: the U E transmits a third message containing an uplink wake-up signal to the fourth node according to the received uplink wake-up signal configuration. In this step, the third message may be included in one or more of the following: preamble. In an embodiment, the preamble may be a preamble for requesting SIB1. Information contained in the third message may refer to the third message mentioned before. In some embodiments, the uplink wake-up signal included in the third message may include an uplink wake-up signal for waking up the energy-saving cell in the first node.

Step 608A: the third node or the fourth node transmits SIB1 information of an energy-saving cell to the UE. It may be transmitted in Mode W and/or Mode V. In some embodiments, the SIB1 information of an energy-saving cell may be determined based on the eleventh message received by the third node (and/or the fourth node) from the second node (and/or the first node).

### Mode W:

Step 608A.w: the fourth node transmits SIB1 information of the energy-saving cell to the UE (herein, it may also be called SIB1 information associated with the first node and/or the second node), for example, it may be transmitted through a twentieth message including the SIB1 information of the energy-saving cell. The SIB1 information of the energy-saving cell may be transmitted by means of SIB1 broadcast of the fourth node or by means of MAC CE. This step may also be that the fourth node transmits SIB1 information of the energy-saving cell to the UE (herein, it may also be called SIB1 information associated with the first node and/or the second node) through a third node. For example, it may be transmitted through a twentieth message including the SIB1 information of the energy-saving cell. For example, the twentieth message may be included in one or more of the following: MIB, SIB1 and broadcast message, etc., and the twentieth message may be transmitted to the U E by the fourth node through a third node. This step may also be that the third node transmits SIB1 information of the energy-saving cell to the UE (herein, it may also be called SIB1 information associated with the first node and/or the second node). For example, it may be transmitted through a twentieth message including the SIB1 information of the energy-saving cell.

### Mode V:

Step 608A.v1: the fourth node transmits a fourth message including a request for SIB1 information transmission to the third node. In this step, the fourth message may be included in one or more of the following: gNB DU configuration update message, gNB CU configuration update confirmation/acknowledge message, F1 setup request message, etc. Information contained in the fourth message may refer to the mentioned fourth message.

Optionally, the third node may transmit a confirmation/acknowledge message to the fourth node to confirm the reception of the transmission request of SIB1, and/or to confirm whether the transmission of SIB1 can be performed according to the request.

Step 608A.v2: the third node transmits SIB1 information of an energy-saving cell to the UE. SIB1 information of the energy-saving cell may be transmitted by RRC message. The RRC message may include one or more of the following: RRC release message, RRC establishment message, RRC reestablishment message, RRC reconfiguration message, RRC resume message, etc.

FIG. 6B illustrates a method for supporting network energy-saving according to embodiments of the disclosure. Specifically, FIG. 6B shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Steps 601B to 606B refer to steps 601A to 602A in FIG. 6A.

Step 606B: the U E transmits a preamble to the first node.

Step 606B: the first node transmits a random access response to the UE.

Step 607B: the UE transmits a third message including an uplink wake-up signal to the third node. In this step, the third message may be transmitted through an RRC message. The RRC message may include one or more of the following: RRC release request message, RRC establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 606B: the third node or the fourth node transmits SIB1 information of an energy-saving cell to the UE. It may be transmitted through Mode R and/or Mode S and/or Mode T.

### Mode R:

Step 608B.r: the third node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc. For example, the SIB1 information may be included in Message 4 (Msg 4) of a random access process.

### Mode S:

Step 608B.s1: optionally, the third node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. Information contained in the fifth message may refer to the mentioned fifth message.

Step 608B.s2: the third node transmits a fourth message including a request for SIB1 information transmission to the fourth node. In this step, the fourth message may be included in one or more of the following: gNB CU configuration update message, gNB DU configuration update confirmation/acknowledge message, F1 setup request response, system information transmission command message, etc. Information contained in the fourth message may refer to the mentioned fourth message.

Optionally, the fourth node may transmit a confirmation/acknowledge message to the third node to confirm the reception of the transmission request of SIB1, and/or to confirm whether the transmission of SIB1 can be performed according to the request.

Step 608B.s3: the fourth node transmits SIB1 information of an energy-saving cell (herein, it may also be called SIB1 information associated with the first node and/or the second node) to the UE. For example, it may be transmitted through a twentieth message including the SIB1 information of the energy-saving cell. The SIB1 information may be transmitted by means of SIB1 broadcast or by means of MAC CE. This step may also be that the fourth node transmits SIB1 information of the energy-saving cell to the UE (herein, it may also be called SIB1 information associated with the first node and/or the second node) through a third node. For example, it may be transmitted through a twentieth message including the SIB1 information of the energy-saving cell. For example, the twentieth message may be included in one or more of the following: MIB, SIB1 and broadcast message, etc., and the twentieth message may be transmitted to the UE by the fourth node through a third node. This step may also be that the third node transmits SIB1 information of the energy-saving cell to the UE (herein, it may also be called SIB1 information associated with the first node and/or the second node). For example, it may be transmitted through a twentieth message including the SIB1 information of the energy-saving cell.

### Mode T:

Step 608B.t1: optionally, the third node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. Information contained in the fifth message may refer to the mentioned fifth message.

Step 608B.t2: the third node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc.

FIG. 6C illustrates a method for supporting network energy-saving according to embodiments of the disclosure. Specifically, FIG. 6C shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Steps 601C to 606C refer to steps 601A to 606A in FIG. 6A.

Step 607C: the U E transmits a third message containing an uplink wake-up signal to the fourth node according to the received uplink wake-up signal configuration. In this step, the third message may be included in one or more of the following: preamble. In an embodiment, the preamble may be a preamble for requesting SIB1. Information contained in the third message may refer to the third message mentioned before.

Step 608C: the third node or the fourth node transmits SIB1 information of an energy-saving cell to the UE. It may be transmitted through Mode O and/or Mode P.

### Mode O:

Step 608C.o1: the fourth node transmits a twelfth message containing a request for SIB1 information of an energy-saving cell to the third node, so as to request the third node to report the SIB1 information of the energy-saving cell. In this step, the twelfth message may be included in one or more of the following: gNB DU configuration update message, gNB CU configuration update confirmation/acknowledge message, F1 setup request message, etc. The twelfth message may include one or more of the following fields and/or related information:
request for SIB1 information of an energy-saving cell: indicates that the SIB1 information of an energy-saving cell is requested.
cell identification of an energy-saving cell.

Step 608C.o2: the third node transmits a twelfth message containing a request for SIB1 information of an energy-saving cell to the second node, so as to request the second node to report the SIB1 information of the energy-saving cell. In this step, the twelfth message may be included in one or more of the following: NG-RAN node configuration update message, NG-RAN node configuration update confirmation/acknowledge message, Xn setup request message, Xn setup request response message, etc. Information contained in the twelfth message may refer to the mentioned twelfth message.

Step 608C.o4: the second node transmits a thirteenth message containing SIB1 information of the energy-saving cell to the third node. In this step, the thirteenth message may be included in one or more of the following: NG-RAN node configuration update message, NG-RAN node configuration update confirmation/acknowledge message, Xn setup request message, Xn setup request response message, etc. The thirteenth message may include one or more of the following fields and/or related information:
SIB1 information of an energy-saving cell; and/or
cell identification of an energy-saving cell.

Step 608C.o4: the third node transmits a thirteenth message containing SIB1 information of the energy-saving cell to the fourth node. In this step, the thirteenth message may be included in one or more of the following: gNB CU configuration update message, gNB DU configuration update confirmation/acknowledge message, F1 setup request response message, etc. Information contained in the thirteenth message may refer to the mentioned thirteenth message.

Step 608C.o5: the fourth node transmits SIB1 information of an energy-saving cell (herein, it may also be called SIB1 information associated with the first node and/or the second node) to the UE. For example, it may be transmitted through a twentieth message including the SIB1 information of the energy-saving cell. The SIB1 information of the energy-saving cell may be transmitted by means of SIB1 broadcast of the fourth node or by means of MAC CE. This step may also be that the fourth node transmits SIB1 information of the energy-saving cell to the UE (herein, it may also be called SIB1 information associated with the first node and/or the second node) through a third node. For example, it may be transmitted through a twentieth message including the SIB1 information of the energy-saving cell. For example, the twentieth message may be included in one or more of the following: MIB, SIB1 and broadcast message, etc., and the twentieth message may be transmitted to the U E by the fourth node through a third node. This step may also be that the third node transmits SIB1 information of the energy-saving cell to the UE (herein, it may also be called SIB1 information associated with the first node and/or the second node). For example, it may be transmitted through a twentieth message including the SIB1 information of the energy-saving cell.

### Mode P:

Step 608C.p1: the fourth node transmits a fourth message including a request for transmission of SIB1 information of the energy-saving cell to the third node. In this step, the fourth message may be included in one or more of the following: gNB DU configuration update message, gNB CU configuration update confirmation/acknowledge message, F1 setup request message, etc. Information contained in the fourth message may refer to the mentioned fourth message.

Optionally, the third node may transmit a confirmation/acknowledge message to the fourth node to confirm the fourth message, and/or transmit information of whether SIB1 information of the energy-saving cell can be transmitted according to the request.

Step 608C.p2: the third node transmits a twelfth message containing a request for SIB1 information of an energy-saving cell to the second node, so as to request the second node to report the SIB1 information of the energy-saving cell. In this step, the twelfth message may be included in one or more of the following: NG-RAN node configuration update message, NG-RAN node configuration update confirmation/acknowledge message, Xn setup request message, Xn setup request response message, etc. Information contained in the twelfth message may refer to the mentioned twelfth message.

Step 608C.p3: the second node transmits a thirteenth message containing SIB1 information of the energy-saving cell to the third node. In this step, the thirteenth message may be included in one or more of the following: NG-RAN node configuration update message, NG-RAN node configuration update confirmation/acknowledge message, Xn setup request message, Xn setup request response message, etc. Information contained in the thirteenth message may refer to the mentioned thirteenth message.

Step 608C.p4; the third node transmits SIB1 information of an energy-saving cell to the UE. SIB1 information of the energy-saving cell may be transmitted by RRC message. The RRC message may include one or more of the following: RRC release message, RRC establishment message, RRC reestablishment message, RRC reconfiguration message, RRC resume message, etc.

FIG. 6D illustrates a method for supporting network energy-saving according to embodiments of the disclosure. Specifically, FIG. 6D shows a process of exchanging on-demand SIB1 related information between nodes, so that the UE can request a node to transmit SIB1 information. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Steps 601D to 606D refer to steps 601A to 606A in FIG. 6A.

Step 607D: the UE transmits a preamble to the fourth node.

Step 608D: the fourth node transmits a random access response to the UE.

Step 609d: the UE transmits a third message including an uplink wake-up signal to the third node. In this step, the third message may be transmitted through an RRC message. The RRC message may include one or more of the following: RRC release request message, RRC establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 610D: the third node or the fourth node transmits SIB1 information of an energy-saving cell to the UE. It may be transmitted by Mode L and/or Mode M and/or Mode N.

### Mode L:

Step 610D.1l: the third node transmits a twelfth message containing a request for SIB1 information of an energy-saving cell to the second node, so as to request the second node to report the SIB1 information of the energy-saving cell. In this step, the twelfth message may be included in one or more of the following: NG-RAN node configuration update message, NG-RAN node configuration update confirmation/acknowledge message, Xn setup request message, Xn setup request response message, etc. Information contained in the twelfth message may refer to the mentioned twelfth message.

Step 610D.l2: the second node transmits a thirteenth message containing SIB1 information of the energy-saving cell to the third node. In this step, the thirteenth message may be included in one or more of the following: NG-RAN node configuration update message, NG-RAN node configuration update confirmation/acknowledge message, Xn setup request message, Xn setup request response message, etc. Information contained in the thirteenth message may refer to the mentioned thirteenth message.

Step 610D.l3: the third node transmits SIB1 information of an energy-saving cell to the UE. SIB1 information of the energy-saving cell may be transmitted by RRC message. The RRC message may include one or more of the following: RRC release message, RRC establishment message, RRC reestablishment message, RRC reconfiguration message, RRC resume message, etc. For example, SIB1 information of the energy-saving cell may be included in Message 4 (Msg 4) of a random access process.

### Mode M:

Step 610D.m1: optionally, the third node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. Information contained in the fifth message may refer to the mentioned fifth message.

Step 610D.m2: the third node transmits a twelfth message containing a request for SIB1 information of an energy-saving cell to the second node, so as to request the second node to report the SIB1 information of the energy-saving cell. In this step, the twelfth message may be included in one or more of the following: NG-RAN node configuration update message, NG-RAN node configuration update confirmation/acknowledge message, Xn setup request message, Xn setup request response message, etc. Information contained in the twelfth message may refer to the mentioned twelfth message.

Step 610D.m3: the second node transmits a thirteenth message containing SIB1 information of the energy-saving cell to the third node. In this step, the thirteenth message may be included in one or more of the following: NG-RAN node configuration update message, NG-RAN node configuration update confirmation/acknowledge message, Xn setup request message, Xn setup request response message, etc. Information contained in the thirteenth message may refer to the mentioned thirteenth message.

Step 610D.m4: the third node transmits a third message including a request for SIB1 information transmission to the fourth node. In this step, the third message may be included in one or more of the following: gNB CU configuration update message, gNB DU configuration update confirmation/acknowledge message, F1 setup request response, system information transmission command message, etc. Information contained in the third message may refer to the third message mentioned before.

Optionally, the fourth node may transmit a confirmation/acknowledge message to the third node to confirm the reception of the transmission request of SIB1, and/or to confirm whether the transmission of SIB1 can be performed according to the request.

Step 610D.m5: the fourth node transmits SIB1 information of an energy-saving cell (herein, it may also be called SIB1 information associated with the first node and/or the second node) to the UE. For example, it may be transmitted through a twentieth message including the SIB1 information of the energy-saving cell. The SIB1 information may be transmitted by means of SIB1 broadcast or by means of MAC CE. This step may also be that the fourth node transmits SIB1 information of the energy-saving cell to the UE (herein, it may also be called SIB1 information associated with the first node and/or the second node) through a third node. For example, it may be transmitted through a twentieth message including the SIB1 information of the energy-saving cell. For example, the twentieth message may be included in one or more of the following: MIB, SIB1 and broadcast message, etc., and the twentieth message may be transmitted to the UE by the fourth node through a third node. This step may also be that the third node transmits SIB1 information of the energy-saving cell to the UE (herein, it may also be called SIB1 information associated with the first node and/or the second node). For example, it may be transmitted through a twentieth message including the SIB1 information of the energy-saving cell.

### Mode N:

Step 610D.n1: optionally, the third node transmits a fifth message including a transmission mode of on-demand SIB1 to the UE. In this step, the fifth message may be transmitted through an RRC message. The RRC message may include one or more of the following: RRC release message, RRC establishment message, RRC reestablishment message, RRC reconfiguration message, RRC resume message, etc. For example, the fifth message may be included in Message 4 (Msg 4) of a random access process. Information contained in the fifth message may refer to the mentioned fifth message.

Step 610D.n2: the third node transmits a twelfth message containing a request for SIB1 information of an energy-saving cell to the second node, so as to request the second node to report the SIB1 information of the energy-saving cell. In this step, the twelfth message may be included in one or more of the following: NG-RAN node configuration update message, NG-RAN node configuration update confirmation/acknowledge message, Xn setup request message, Xn setup request response message, etc. Information contained in the twelfth message may refer to the mentioned twelfth message.

Step 610D.n3: the second node transmits a thirteenth message containing SIB1 information of the energy-saving cell to the third node. In this step, the thirteenth message may be included in one or more of the following: NG-RAN node configuration update message, NG-RAN node configuration update confirmation/acknowledge message, Xn setup request message, Xn setup request response message, etc. Information contained in the thirteenth message may refer to the mentioned thirteenth message.

Step 610D.n4: the third node transmits SIB1 information of an energy-saving cell to the UE. The SIB1 information may be transmitted by an RRC message. The RRC message may include one or more of the following: RRC release message, RRC establishment message, RRC reestablishment message, RRC reconfiguration message, RRC resume message, etc.

FIG. 6E illustrates a method for supporting network energy-saving according to embodiments of the disclosure. Specifically, FIG. 6E shows a process of exchanging information related to the reception of uplink wake-up signals among nodes for the nodes to make energy-saving related decisions. For example, in an embodiment, for example, the first node may be a gNB DU where an energy-saving cell is located, the second node may be a gNB CU where an energy-saving cell is located, and the third node may be a gNB CU of a normal cell or a gNB of a normal cell.

Step 601E: the first node transmits a fourteenth message including a request for the reception of uplink wake-up signals to the second node to request to report the reception of the uplink wake-up signals. The reception of the uplink wake-up signals may include one or more of the following: the number of times the uplink wake-up signals are received, the signal strength of the received uplink wake-up signals, etc. The number of times the uplink wake-up signals are received may include the number of reception times of uplink wake-up signals received from one or more UEs, and/or it may also include information of how many UEs the uplink wake-up signals are received from, that is, the number of UEs from which the uplink wake-up signals are received. In some embodiments, the uplink wake-up signal may be an uplink wake-up signal related to an energy-saving cell in the first node. In this step, the fourteenth message may be included in one or more of the following: gNB DU configuration update message, gNB CU configuration update confirmation/acknowledge message, F1 setup request message, etc. The fourteenth message may include one or more of the following fields and/or related information:
identification of a request to report the reception of the uplink wake-up signal: used to indicate a request to report the reception of the uplink wake-up signal.
content of a request to report the reception of the uplink wake-up signal: used to indicate the content of a request to report the reception of the uplink wake-up signal. The content may include one or more of the following: the number of times the uplink wake-up signals are received, the signal strength of the received uplink wake-up signals, etc.
collection time corresponding to the reception of the uplink wake-up signal.
reporting time corresponding to the reception of the uplink wake-up signal.
collection window corresponding to the reception of the uplink wake-up signal: used to indicate that the reception of the uplink wake-up signal is collected and/or processed within this collection time window. For example, the processing may be to obtain an average value and/or an evaluation value.
triggering condition and/or event for requesting to report the reception of the uplink wake-up signal: for example, when the following conditions and/or events are met, the reception of the uplink wake-up signal is reported:
Condition and/or Event 1: the number of reception times of an uplink wake-up signal is greater than and/or equal to a threshold value. The event and/or condition includes one or more of the following: condition and/or event type, condition and/or event, threshold value, etc.
Condition and/or Event 2: the number of reception times of an uplink wake-up signal within a certain period of time is greater than and/or equal to a threshold value. The event and/or condition includes one or more of the following: condition and/or event type, condition and/or event, threshold value, the time, etc.
Condition and/or Event 3: the signal quality of the received uplink wake-up signal is less than and/or greater than and/or equal to a threshold value. The event and/or condition includes one or more of the following: condition and/or event type, condition and/or event, threshold value, etc.
Condition and/or Event 4: the average signal quality of the uplink wake-up signal received within a certain period of time is less than and/or greater than and/or equal to a threshold value. The event and/or condition includes one or more of the following: condition and/or event type, condition and/or event, threshold value, the time, etc.
Condition and/or Event 5: the maximum and/or minimum signal quality of the uplink wake-up signal received within a certain period of time is less than and/or greater than and/or equal to a threshold value. The event and/or condition includes one or more of the following: condition and/or event type, condition and/or event, threshold value, the time, etc.

It should be understood that the above-mentioned conditions and/or events are only examples, and the embodiments of the disclosure may also include any other suitable conditions and/or events, and the fourteenth message may also include the above-mentioned and/or any other threshold value, time range, etc. for triggering the reporting of the reception of the uplink wake-up signal.

In some embodiments, the threshold value, time range, etc. for triggering the reporting of the reception of the uplink wake-up signal may also be included in the eleventh message or any other message mentioned above, or may be transmitted through any other separate message different from the messages listed here, which is not limited herein.

Step 602E: the second node transmits a fourteenth message including a request for the reception of uplink wake-up signals to the third node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: NG-RAN node configuration update message, NG-RAN node configuration update confirmation/acknowledge message, Xn setup request message, Xn setup request response message, etc. Information contained in the fourteenth message refers to the mentioned fourteenth message.

Optionally, after receiving the fourteenth message, the node transmits a confirmation/acknowledge message to the transmitting node of the fourteenth message to confirm the reception of the fourteenth message and/or to inform whether reporting may be performed according to the request of the fourteenth message. For example, it may include one or more of the following: the third node transmits a confirmation/acknowledge message to the second node, and the second node transmits a confirmation/acknowledge message to the first node.

Step 603E: the UE transmits a third message including an uplink wake-up signal to the third node. In this step, the third message may be transmitted through an RRC message. The RRC message may include one or more of the following: RRC release request message, RRC establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 604E: the third node transmits a fifteenth message including the reception of the uplink wake-up signal to the second node. In this step, the fifteenth message may be included in one or more of the following: NG-RAN node configuration update message, NG-RAN node configuration update confirmation/acknowledge message, Xn setup request message, Xn setup request response message, etc. The fifteenth message may include one or more of the following fields and/or related information:
identification of the reporting of the reception of the uplink wake-up signal: used to indicate that the message is used to report the reception of the uplink wake-up signal.
content of the reporting of the reception of the uplink wake-up signal: the content may include one or more of the following: the number of times the uplink wake-up signals are received, the signal strength of the received uplink wake-up signals, etc.
collection time corresponding to the reported reception of the uplink wake-up signal.
reporting time corresponding to the reported reception of the uplink wake-up signal.
collection window corresponding to the reported reception of the uplink wake-up signal: used to indicate that the reported reception of the uplink wake-up signal is collected and/or processed within this collection time window. For example, the processing may be to obtain an average value and/or an evaluation value.
triggering condition and/or event for the reporting of the reception of the uplink wake-up signal: it may include one or more of the following:
Condition and/or Event 1: the number of reception times of an uplink wake-up signal is greater than and/or equal to a threshold value. The event and/or condition includes one or more of the following: condition and/or event type, condition and/or event, threshold value, etc.
Condition and/or Event 2: the number of reception times of an uplink wake-up signal within a certain period of time is greater than and/or equal to a threshold value. The event and/or condition includes one or more of the following: condition and/or event type, condition and/or event, threshold value, the time, etc.
Condition and/or Event 3: the signal quality of the received uplink wake-up signal is less than and/or greater than and/or equal to a threshold value. The event and/or condition includes one or more of the following: condition and/or event type, condition and/or event, threshold value, etc.
Condition and/or Event 4: the average signal quality of the uplink wake-up signal received within a certain period of time is less than and/or greater than and/or equal to a threshold value. The event and/or condition includes one or more of the following: condition and/or event type, condition and/or event, threshold value, the time, etc.
Condition and/or Event 5: the maximum and/or minimum signal quality of the uplink wake-up signal received within a certain period of time is less than and/or greater than and/or equal to a threshold value. The event and/or condition includes one or more of the following: condition and/or event type, condition and/or event, threshold value, the time, etc.

Step 604E: the second node transmits a fifteenth message including the reception of the uplink wake-up signal to the first node. In this step, the fifteenth message may be included in one or more of the following: gNB CU configuration update message, gNB DU configuration update confirmation/acknowledge message, F1 setup request response, etc. Information contained in the fifteenth message may refer to the mentioned fifteenth message.

Step 605E: the first node decides whether to enter a normal SIB1 transmission state or makes a network energy-saving decision based on the received reception of the uplink wake-up signal.

FIG. 6F illustrates a method for supporting network energy-saving according to embodiments of the disclosure. Specifically, FIG. 6F shows a process of exchanging information related to the reception of uplink wake-up signals among nodes for the nodes to make energy-saving related decisions. For example, in an embodiment, for example, the first node may be a gNB DU where an energy-saving cell is located, the second node may be a gNB CU where an energy-saving cell is located, and the third node may be a gNB CU of a normal cell or a gNB of a normal cell.

Step 601F: the second node transmits a fourteenth message including a request for the reception of uplink wake-up signals to the third node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: NG-RAN node configuration update message, NG-RAN node configuration update confirmation/acknowledge message, Xn setup request message, Xn setup request response message, etc. Information contained in the fourteenth message refers to the mentioned fourteenth message.

Optionally, after receiving the fourteenth message, the node transmits a confirmation/acknowledge message to the transmitting node of the fourteenth message to confirm the reception of the fourteenth message and/or to inform whether reporting may be performed according to the request of the fourteenth message. For example, it may include one or more of the following: the third node transmits a confirmation/acknowledge message to the second node.

Step 602F: the UE transmits a third message including an uplink wake-up signal to the third node. In this step, the third message may be transmitted through an RRC message. The RRC message may include one or more of the following: RRC release request message, RRC establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 603F: the third node transmits a fifteenth message including the reception of the uplink wake-up signal to the second node. In this step, the fifteenth message may be included in one or more of the following: NG-RAN node configuration update message, NG-RAN node configuration update confirmation/acknowledge message, Xn setup request message, Xn setup request response message, etc. Information contained in the fifteenth message may refer to the mentioned fifteenth message.

Step 604F: the second node decides whether to enter a normal SIB1 transmission state or makes a network energy-saving decision based on the received reception of the uplink wake-up signal.

Step 605F: the second node transmits a sixteenth message to the first node, which contains a request to activate a normal transmission state of SIB1. In this step, the sixteenth message may be included in one or more of the following: gNB CU configuration update message, gNB DU configuration update confirmation/acknowledge message, F1 setup request response, etc. The sixteenth message may include one or more of the following fields and/or related information:
request to activate a normal transmission state of SIB1: which indicates a request for a node to enter a normal transmission state of SIB1.
request to activate a non-energy-saving state: which indicates a request for a node to change from an energy-saving state to a non-energy-saving state.
cell ID and/or ID list: indicates the ID and/or ID list of cells corresponding to the request.

After receiving the message, the first node adjusts its energy-saving state and/or energy-saving strategy according to the request.

Optionally, after receiving the sixteenth message, the node may transmit a confirmation/acknowledge message to the transmitting node of the sixteenth message to inform whether to enter an SIB1 normal transmission state. For example, the first node may transmit a confirmation/acknowledge message to the second node. The confirmation/acknowledge message may include one or more of the following: identification of whether to enter a normal transmission state of SIB1, identification of whether to enter a non-energy-saving state, corresponding cell identification and/or identification list, time when a normal transmission state of SIB1 can (not) be entered, and time when a non-energy-saving state can (not) be entered.

FIG. 6G illustrates a method for supporting network energy-saving according to embodiments of the disclosure. Specifically, FIG. 6G shows a process of exchanging information related to a request to activate an SIB1 normal transmission state between nodes, so that the nodes can adjust an energy-saving state and/or strategy. For example, in an embodiment, for example, the first node may be a gNB DU where an energy-saving cell is located, the second node may be a gNB CU where an energy-saving cell is located, and the third node may be a gNB CU of a normal cell or a gNB of a normal cell.

Step 601G: the UE transmits a third message including an uplink wake-up signal to the third node. In this step, the third message may be transmitted through an RRC message. The RRC message may include one or more of the following: RRC release request message, RRC establishment request message, RRC reestablishment request message, RRC reconfiguration request message, RRC resume request message, RRC system information request message, etc. For example, the third message may be included in Message 3 (Msg 3) of a random access process. Information contained in the third message may refer to the third message mentioned before.

Step 602G: the third node decides whether to enter a normal SIB1 transmission state or makes a network energy-saving decision based on the received reception of the uplink wake-up signal.

Step 603G: the third node transmits a sixteenth message to the second node, which contains a request to activate a normal transmission state of SIB1. In this step, the sixteenth message may be included in one or more of the following: NG-RAN node configuration update message, NG-RAN node configuration update confirmation/acknowledge message, Xn setup request message, X n setup request response message, etc. Information contained in the sixteenth message refers to the mentioned sixteenth message.

Step 604G: the second node transmits a sixteenth message to the first node, which contains a request to activate a normal transmission state of SIB1. In this step, the sixteenth message may be included in one or more of the following: gNB CU configuration update message, gNB DU configuration update confirmation/acknowledge message, F1 setup request response, etc. Information contained in the sixteenth message refers to the mentioned sixteenth message.

After receiving the message, the first node adjusts its energy-saving state and/or energy-saving strategy according to the request.

Optionally, after receiving the sixteenth message, the node may transmit a confirmation/acknowledge message to the transmitting node of the sixteenth message to inform whether to enter an SIB1 normal transmission state. For example, a first node may transmit a confirmation/acknowledge message to a second node, and the second node may transmit a confirmation/acknowledge message to a third node. The confirmation/acknowledge message may include one or more of the following: identification of whether to enter a normal transmission state of SIB1, identification of whether to enter a non-energy-saving state, corresponding cell identification and/or identification list, time when a normal transmission state of SIB1 can (not) be entered, and time when a non-energy-saving state can (not) be entered.

FIG. 6H illustrates a method for supporting network energy-saving according to embodiments of the disclosure. Specifically, FIG. 6H shows a process of exchanging information related to the reception of uplink wake-up signals among nodes for the nodes to make energy-saving related decisions. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Step 601H: the first node transmits a fourteenth message including a request for the reception of uplink wake-up signals to the second node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: gNB DU configuration update message, gNB CU configuration update confirmation/acknowledge message, F1 setup request message, etc. Information contained in the fourteenth message may refer to the mentioned fourteenth message.

Step 602H: the second node transmits a fourteenth message including a request for the reception of uplink wake-up signals to the third node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: NG-RAN node configuration update message, NG-RAN node configuration update confirmation/acknowledge message, Xn setup request message, Xn setup request response message, etc. Information contained in the fourteenth message refers to the mentioned fourteenth message.

Step 603H: the third node transmits a fourteenth message including a request for the reception of uplink wake-up signals to the fourth node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: gNB CU configuration update message, gNB DU configuration update confirmation/acknowledge message, F1 setup request response, etc. Information contained in the fourteenth message refers to the mentioned fourteenth message.

Optionally, after receiving the fourteenth message, the node transmits a confirmation/acknowledge message to the transmitting node of the fourteenth message to confirm the reception of the fourteenth message and/or to inform whether reporting may be performed according to the request of the fourteenth message. For example, it may include one or more of the following: the fourth node transmits a confirmation/acknowledge message to the third node, the third node transmits a confirmation/acknowledge message to the second node, and the second node transmits a confirmation/acknowledge message to the first node.

Step 604H: the UE transmits a third message including an uplink wake-up signal to the fourth node. In this step, the third message may be included in one or more of the following: preamble. In an embodiment, the preamble may be a preamble for requesting SIB1. Information contained in the third message may refer to the third message mentioned before.

Step 605H: the fourth node transmits a fifteenth message including the reception of the uplink wake-up signal (for example, received by the fourth node) to the third node. In this step, the fifteenth message may be included in one or more of the following: gNB DU configuration update message, gNB CU configuration update confirmation/acknowledge message, F1 setup request message, etc. Information contained in the fifteenth message may refer to the mentioned fifteenth message.

Step 606H: the third node transmits a fifteenth message including the reception of the uplink wake-up signal (for example, received by the fourth node) to the second node. In this step, the fifteenth message may be included in one or more of the following: NG-RAN node configuration update message, NG-RAN node configuration update confirmation/acknowledge message, Xn setup request message, Xn setup request response message, etc. Information contained in the fifteenth message may refer to the mentioned fifteenth message.

Step 607H: the second node transmits a fifteenth message including the reception of the uplink wake-up signal to the first node. In this step, the fifteenth message may be included in one or more of the following: gNB CU configuration update message, gNB DU configuration update confirmation/acknowledge message, F1 setup request response, etc. Information contained in the fifteenth message may refer to the mentioned fifteenth message.

Step 608H: the first node decides whether to enter an SIB1 normal transmission state, and/or makes a network energy-saving decision based on the received reception of the uplink wake-up signal.

FIG. 6I illustrates a method for supporting network energy-saving according to embodiments of the disclosure. Specifically, FIG. 6I shows a process of exchanging information related to the reception of uplink wake-up signals among nodes for the nodes to make energy-saving related decisions. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Step 602I: the second node transmits a fourteenth message including a request for the reception of uplink wake-up signals to the third node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: NG-RAN node configuration update message, NG-RAN node configuration update confirmation/acknowledge message, Xn setup request message, Xn setup request response message, etc. Information contained in the fourteenth message refers to the mentioned fourteenth message.

Step 603I: the third node transmits a fourteenth message including a request for the reception of uplink wake-up signals to the fourth node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: gNB CU configuration update message, gNB DU configuration update confirmation/acknowledge message, F1 setup request response, etc. Information contained in the fourteenth message refers to the mentioned fourteenth message.

Optionally, after receiving the fourteenth message, the node transmits a confirmation/acknowledge message to the transmitting node of the fourteenth message to confirm the reception of the fourteenth message and/or to inform whether reporting may be performed according to the request of the fourteenth message. For example, it may include one or more of the following: the fourth node transmits a confirmation/acknowledge message to the third node, and the third node transmits a confirmation/acknowledge message to the second node.

Step 604I: the UE transmits a third message including an uplink wake-up signal to the fourth node. In this step, the third message may be included in one or more of the following: preamble. In an embodiment, the preamble may be a preamble for requesting SIB1. Information contained in the third message may refer to the third message mentioned before.

Step 605I: the fourth node transmits a fifteenth message including the reception of the uplink wake-up signal to the third node. In this step, the fifteenth message may be included in one or more of the following: gNB DU configuration update message, gNB CU configuration update confirmation/acknowledge message, F1 setup request message, etc. Information contained in the fifteenth message may refer to the mentioned fifteenth message.

Step 606I: the third node transmits a fifteenth message including the reception of the uplink wake-up signal to the second node. In this step, the fifteenth message may be included in one or more of the following: NG-RAN node configuration update message, NG-RAN node configuration update confirmation/acknowledge message, Xn setup request message, Xn setup request response message, etc. Information contained in the fifteenth message may refer to the mentioned fifteenth message.

Step 607I: the second node decides whether to enter a normal SIB1 transmission state or makes a network energy-saving decision based on the received reception of the uplink wake-up signal.

Step 608I: the second node transmits a sixteenth message to the first node, which contains a request to activate a normal transmission state of SIB1. In this step, the sixteenth message may be included in one or more of the following: gNB CU configuration update message, gNB DU configuration update confirmation/acknowledge message, F1 setup request response, etc. Information contained in the sixteenth message refers to the mentioned sixteenth message.

After receiving the message, the first node adjusts its energy-saving state and/or energy-saving strategy according to the request.

Optionally, after receiving the sixteenth message, the node may transmit a confirmation/acknowledge message to the transmitting node of the sixteenth message to inform whether to enter an SIB1 normal transmission state. For example, the first node may transmit a confirmation/acknowledge message to the second node. The confirmation/acknowledge message may include one or more of the following: identification of whether to enter a normal transmission state of SIB1, identification of whether to enter a non-energy-saving state, corresponding cell identification and/or identification list, time when a normal transmission state of SIB1 can (not) be entered, and time when a non-energy-saving state can (not) be entered.

FIG. 6J illustrates a method for supporting network energy-saving according to embodiments of the disclosure. Specifically, FIG. 6J shows a process of exchanging information related to the reception of uplink wake-up signals among nodes for the nodes to make energy-saving related decisions. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Step 601J: the third node transmits a fourteenth message including a request for the reception of uplink wake-up signals to the fourth node to request to report the reception of the uplink wake-up signals. The reception of the uplink wake-up signals may include one or more of the following: the number of times the uplink wake-up signals are received, the signal strength of the received uplink wake-up signals, etc. In this step, the fourteenth message may be included in one or more of the following: gNB CU configuration update message, gNB DU configuration update confirmation/acknowledge message, F1 setup request response, etc. Information contained in the fourteenth message refers to the mentioned fourteenth message.

Optionally, after receiving the fourteenth message, the node transmits a confirmation/acknowledge message to the transmitting node of the fourteenth message to confirm the reception of the fourteenth message and/or to inform whether reporting may be performed according to the request of the fourteenth message. For example, it may include one or more of the following: the fourth node transmits a confirmation/acknowledge message to the third node.

Step 602J: the UE transmits a third message including an uplink wake-up signal to the fourth node. In this step, the third message may be included in one or more of the following: preamble. In an embodiment, the preamble may be a preamble for requesting SIB1. Information contained in the third message may refer to the third message mentioned before.

Step 603J: the fourth node transmits a fifteenth message including the reception of the uplink wake-up signal to the third node. In this step, the fifteenth message may be included in one or more of the following: gNB DU configuration update message, gNB CU configuration update confirmation/acknowledge message, F1 setup request message, etc. Information contained in the fifteenth message may refer to the mentioned fifteenth message.

Step 604J: the third node decides whether to enter a normal SIB1 transmission state or makes a network energy-saving decision based on the received reception of the uplink wake-up signal.

Step 605J: the third node transmits a sixteenth message to the second node, which contains a request to activate a normal transmission state of SIB1. In this step, the sixteenth message may be included in one or more of the following: NG-RAN node configuration update message, NG-RAN node configuration update confirmation/acknowledge message, Xn setup request message, Xn setup request response message, etc. Information contained in the sixteenth message refers to the mentioned sixteenth message.

Step 606J: the second node transmits a sixteenth message to the first node, which contains a request to activate a normal transmission state of SIB1. In this step, the sixteenth message may be included in one or more of the following: gNB CU configuration update message, gNB DU configuration update confirmation/acknowledge message, F1 setup request response, etc. Information contained in the sixteenth message refers to the mentioned sixteenth message.

After receiving the message, the first node adjusts its energy-saving state and/or energy-saving strategy according to the request.

Optionally, after receiving the sixteenth message, the node may transmit a confirmation/acknowledge message to the transmitting node of the sixteenth message to inform whether to enter an SIB1 normal transmission state. For example, a first node may transmit a confirmation/acknowledge message to a second node, and the second node may transmit a confirmation/acknowledge message to a third node. The confirmation/acknowledge message may include one or more of the following: identification of whether to enter a normal transmission state of SIB1, identification of whether to enter a non-energy-saving state, corresponding cell identification and/or identification list, time when a normal transmission state of SIB1 can (not) be entered, and time when a non-energy-saving state can (not) be entered.

FIG. 6K illustrates a method for supporting network energy-saving according to embodiments of the disclosure. Specifically, FIG. 6K shows a process of exchanging information related to a request to activate an SIB1 normal transmission state between nodes, so that the nodes can adjust an energy-saving state and/or strategy. For example, in an embodiment, for example, the first node may be a gNB DU where an energy-saving cell is located, the second node may be a gNB CU where an energy-saving cell is located, the third node may be a gNB CU of a normal cell, and the fourth node may be a gNB DU of a normal cell.

Step 601K: the UE transmits a third message including an uplink wake-up signal to the fourth node. In this step, the third message may be included in one or more of the following: preamble. In an embodiment, the preamble may be a preamble for requesting SIB1. Information contained in the third message may refer to the third message mentioned before.

Step 602K: the fourth node decides whether to enter a normal SIB1 transmission state or makes a network energy-saving decision based on the received reception of the uplink wake-up signal.

Step 603K: the fourth node transmits a sixteenth message to the third node, which contains a request to activate a normal transmission state of SIB1. In this step, the sixteenth message may be included in one or more of the following: gNB DU configuration update message, gNB CU configuration update confirmation/acknowledge message, F1 setup request message, etc. Information contained in the sixteenth message refers to the mentioned sixteenth message.

Step 604K: the third node transmits a sixteenth message to the second node, which contains a request to activate a normal transmission state of SIB1. In this step, the sixteenth message may be included in one or more of the following: NG-RAN node configuration update message, NG-RAN node configuration update confirmation/acknowledge message, Xn setup request message, X n setup request response message, etc. Information contained in the sixteenth message refers to the mentioned sixteenth message.

Step 605K: the second node transmits a sixteenth message to the first node, which contains a request to activate a normal transmission state of SIB1. In this step, the sixteenth message may be included in one or more of the following: gNB CU configuration update message, gNB DU configuration update confirmation/acknowledge message, F1 setup request response, etc. Information contained in the sixteenth message refers to the mentioned sixteenth message.

After receiving the message, the first node adjusts its energy-saving state and/or energy-saving strategy according to the request.

Optionally, after receiving the sixteenth message, the node may transmit a confirmation/acknowledge message to the transmitting node of the sixteenth message to inform whether to enter an SIB1 normal transmission state. For example, the first node may transmit a confirmation/acknowledge message to the second node, the second node transmits a confirmation/acknowledge message to the third node, and the third node transmits a confirmation/acknowledge message to the fourth node. The confirmation/acknowledge message may include one or more of the following: identification of whether to enter a normal transmission state of SIB1, identification of whether to enter a non-energy-saving state, corresponding cell identification and/or identification list, time when a normal transmission state of SIB1 can (not) be entered, and time when a non-energy-saving state can (not) be entered.

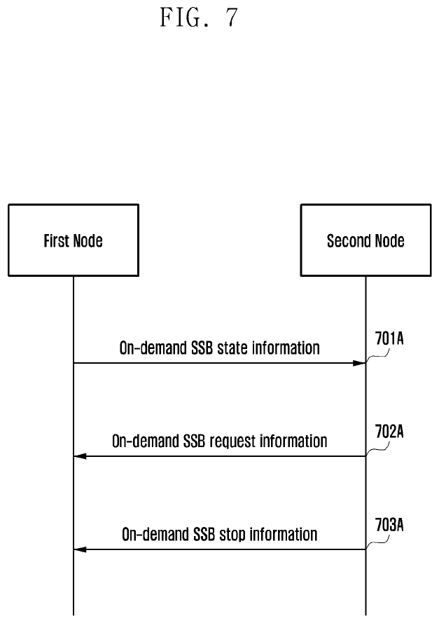

FIG. 7 illustrates a method for supporting network energy-saving according to embodiments of the disclosure. Specifically, FIG. 7 shows a process of exchanging on-demand SSB related information among nodes for the nodes to adjust an energy-saving state and/or energy-saving strategy. For example, in an embodiment, for example, the first node may be a gNB DU where an energy-saving cell is located, and the second node may be a gNB CU where an energy-saving cell is located. In an embodiment, for example, the first node may be a gNB or a gNB-CU or a gNB-DU or a gNB CU-CP or a gNB CU-UP or an en-gNB or an eNB or an ng-eNB, and the second node may be a UE. In another embodiment, for example, the first node may be a gNB or a gNB-CU or a gNB-DU or a gNB CU-CP or a gNB CU-UP or an en-gNB or an eNB or an ng-eNB, and the second node may be a gNB or a gNB-CU or a gNB-DU or a gNB CU-CP or a gNB CU-UP or an en-gNB or an eNB or an ng-eNB. In yet another embodiment, for example, the first node may be an AMF or an SMF or an MME, and the second node may be a gNB or a gNB-CU or a gNB CU-CP or an en-gNB or an eNB or an ng-eNB. In yet another embodiment, for example, the first node may be a gNB or a gNB-CU or a gNB CU-CP or an en-gNB or an eNB or an ng-eNB, and the second node may be an AMF or an SMF or an MME.

Step 701A: the first node transmits a sixteenth message containing on-demand SSB state information to the second node to inform the second node of the on-demand SSB state information. The sixteenth message may include one or more of the following:
SSB state: it may include one or more of the following: on-demand SSB, normal SSB, long-period SSB and short-period SSB.
cell identification.
beam identification.
time information corresponding to an SSB state.

Step 702A: the second node transmits a seventeenth message containing on-demand SSB request information to the first node to request to adjust an energy-saving decision. The seventeenth message includes one or more of the following fields and/or related information:
cell identification;
beam identification;
SSB transmission time;
SSB transmission period;
number of SSB transmission times;
SSB transmission period outside the SSB transmission time;
number of SSB transmission times outside the SSB transmission time;
identification of a request to start on-demand SSB; and/or
identification of a request to stop on-demand SSB.

Step 703A: the second node transmits an eighteenth message containing on-demand SSB stop information to the first node to request to stop the on-demand SSB. The eighteenth message includes one or more of the following fields and/or related information:
cell identification;
beam identification; and/or
identification of a request to stop on-demand SSB.

In the disclosure, the embodiments are only taken as examples, and the above embodiments can be combined. For example, any one or more of the examples in FIG. 4C, FIG. 4D, FIG. 4E and FIG. 4F can be combined with any one or more of the examples in FIG. 4A or 4B or 5A or 5B or 6A or 6B or 6C or 6D. For example, any one or more of the examples in FIG. 6E, FIG. 6F, FIG. 6G, FIG. 6H, FIG. 6I, FIG. 6J and FIG. 6K may be combined with any one or more of the examples in FIG. 6A or FIG. 6B or FIG. 6C or FIG. 6D. For example, any one or more of the examples in FIGS. 4A-4F may be combined with any one or more of the examples in FIGS. 5A-5B and/or FIGS. 6A-6K and/or FIG. 7.

In the disclosure, some steps in the embodiments may be omitted or combined.

In the disclosure, orders of the steps in the embodiments can be exchanged.

In the disclosure, under a non-gNB CU gNB DU split architecture, in the above illustration, the first node and the second node may be merged into one node, and the third node and the fourth node may be merged into another node. The exchanging between the first node and the second node is an internal behavior of the node, and the exchanging between the third node and the fourth node is an internal behavior of another node. For example, any gNB CU can be merged with its corresponding gNB DU into one node.

It should be understood that, depending on the application scenario, the various example aspects, methods, steps, processes, etc. shown in the drawings can be combined and implemented in any way, and there is no limitation here.

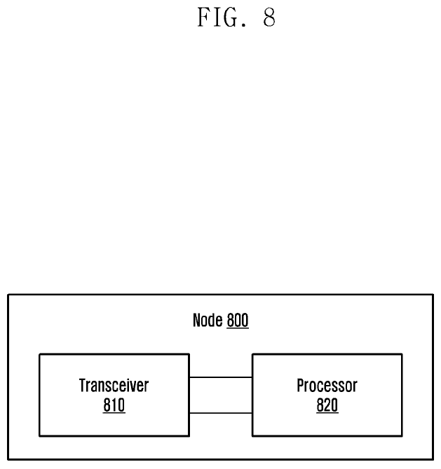

Next, FIG. 8 shows a schematic diagram of a node 800 according to embodiments of the disclosure.

As shown in FIG. 8, a node 800 according to embodiments of the disclosure (e.g., any node as described herein) may include a transceiver 810 and a processor 820. The transceiver 810 may be configured to transmit and receive signals. The processor 820 may be coupled to the transceiver 810 and may be configured to (e.g., control the transceiver 810 to) perform a method performed by any node in a wireless communication system according to embodiments of the disclosure.

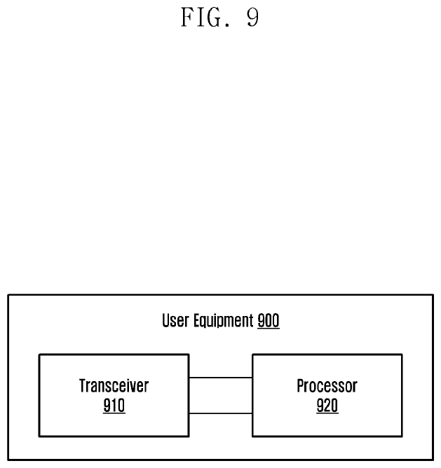

FIG. 9 illustrates a user equipment 900 according to embodiments of the disclosure.

As shown in FIG. 9, a user equipment 900 (or a terminal) according to embodiments of the disclosure may include a transceiver 910 and a processor 920. The transceiver 910 may be configured to transmit and receive signals. The processor 920 may be coupled to the transceiver 910 and may be configured to (e.g., control the transceiver 910 to) perform a method performed by a user equipment (UE) in a wireless communication system according to embodiments of the disclosure. In the disclosure, a processor may also be referred to as a controller. In the disclosure, a node may also be referred to as a node device.

Embodiments of the disclosure also provide a computer-readable medium having stored thereon computer-readable instructions which, when executed by a processor, implement any method according to embodiments of the disclosure.

Various embodiments of the disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the disclosure can be easily explained by those skilled in the art to which the embodiments of the disclosure are applied.

It may be understood that the embodiments of the disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably includes its equivalents.

What has been described above is only the specific embodiment of the disclosure, but the scope of protection of the disclosure is not limited thereto. Anyone who is familiar with this technical field may make various changes or substitutions within the technical scope disclosed in the disclosure, and these changes or substitutions should be covered within the scope of protection of the disclosure. Therefore, the scope of protection of the disclosure should be based on the scope of protection of the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first base station in a communication system, the method comprising:
transmitting, to a second base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration;
receiving, from a terminal via the NES cell, request for an on-demand system information block (SIB) 1, based on the UL WUS configuration; and
transmitting, to the terminal via the NES cell, the on-demand SIB 1, based on the request for the on-demand SIB 1,
wherein the UL WUS configuration is transmitted to the terminal via an SIB broadcasted by the second base station.

2. The method of claim 1, further comprising:
transmitting, from a distributed unit (DU) of the first base station to a centralized unit (CU) of the first base station, a second request message including second information indicating whether to provision the UL WUS configuration associated with the on-demand SIB,
wherein the second request message is a F1 setup request message or a gNB-DU configuration update message.

3. The method of claim 2, wherein, in case that the second information indicates start of the provision, the request type is start, and
wherein, in case that the second information indicates stop of the provision, the request type is stop and the first request message indicates the second base station to stop a broadcasting of the UL WUS configuration and to remove the UL WUS configuration.

4. The method of claim 1, wherein the request for the on-demand SIB 1 is received via a preamble associated with a random access procedure for the NES cell of the first base station.

5. The method of claim 1, further comprising:
receiving, from the second base station, response message including information associated with whether the second base station supports broadcasting of the UL WUS configuration.

6. A method performed by a second base station in a communication system, the method comprising:
receiving, from a first base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration;
storing the UL WUS configuration; and
transmitting, to a terminal, a system information block (SIB) including the UL WUS configuration,
wherein the UL WUS configuration is used for obtaining an on-demand SIB 1 from the NES cell of the first base station.

7. The method of claim 6, wherein, in case that the request type is stop, the first request message indicates the second base station to stop a transmission of the UL WUS configuration and to remove the UL WUS configuration.

8. The method of claim 6, wherein the request for the on-demand SIB 1 is received via a preamble associated with a random access procedure for the NES cell of the first base station.

9. The method of claim 6, further comprising:
transmitting, to the first base station, response message including information associated with whether the second base station supports transmission of the UL WUS configuration.

10. A first base station in a communication system, the first base station comprising:
a transceiver; and
a processor coupled to the transceiver and configured to:
transmit, to a second base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration,
receive, from a terminal via the NES cell, request for an on-demand system information block (SIB) 1, based on the UL WUS configuration, and
transmit, to the terminal via the NES cell, the on-demand SIB 1, based on the request for the on-demand SIB 1,
wherein the UL WUS configuration is transmitted to the terminal via an SIB broadcasted by the second base station.

11. The first base station of claim 10, wherein the processor is further configured to transmit, from a distributed unit (DU) of the first base station to a centralized unit (CU) of the first base station, a second request message including second information indicating whether to provision the UL WUS configuration associated with the on-demand SIB,
wherein the second request message is a F1 setup request message or a gNB-DU configuration update message,
wherein, in case that the second information indicates start of the provision, the request type is start, and
wherein, in case that the second information indicates stop of the provision, the request type is stop and the first request message indicates the second base station to stop a broadcasting of the UL WUS configuration and to remove the UL WUS configuration.

12. The first base station of claim 10, wherein the request for the on-demand SIB 1 is received via a preamble associated with a random access procedure for the NES cell of the first base station, and
wherein the processor is further configured to receive, from the second base station, response message including information associated with whether the second base station supports broadcasting of the UL WUS configuration.

13. A second base station in a communication system, the second base station comprising:
a transceiver; and
a processor coupled to the transceiver and configured to:
receive, from a first base station, a first request message including first information on a request type for a provision of an uplink (UL) wake-up signal (WUS) configuration associated with a network energy saving (NES) cell of the first base station, wherein, in case that the request type is start, the first request message further includes information on the UL WUS configuration,
store the UL WUS configuration, and
transmit, to a terminal, a system information block (SIB) including the UL WUS configuration,
wherein the UL WUS configuration is used for obtaining an on-demand SIB 1 from the NES cell of the first base station.

14. The second base station of claim 13, wherein, in case that the request type is stop, the first request message indicates the second base station to stop a transmission of the UL WUS configuration and to remove the UL WUS configuration.

15. The second base station of claim 13, wherein the request for the on-demand SIB 1 is received via a preamble associated with a random access procedure for the NES cell of the first base station, and
wherein the processor is further configured to transmit, to the first base station, response message including information associated with whether the second base station supports transmission of the UL WUS configuration.
